(19) United States
(12) Patent Application Publication
(10) Pub. No.: US 2008/0033112 A1
(43) Pub. Date: Feb. 7, 2008

(54) Polymer compositions comprising cyclic olefin copolymers and polyolefin modifiers

(76) Inventors: Kevin R. Squire, Kingwood, TX (US); Alan J. Oshinski, Friendswood, TX (US); Kevin D. Robinson, Houston, TX (US); Christian Peter Mehnert, Houston, TX (US); Marsha M. Arvedson, Houston, TX (US); Beverly J. Poole, Houston, TX (US); Abhimanyu Onkar Patil, Westfield, NJ (US); Lisa Saunders Baugh, Ringoes, NJ (US); Karla Schall Colle, Houston, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/820,739

(22) Filed: Jun. 20, 2007

Related U.S. Application Data
(60) Provisional application No. 60/835,524, filed on Aug. 4, 2006.
(60) Provisional application No. 60/836,007, filed on Aug. 7, 2006.

(51) Int. Cl. C08L 23/00

(52) U.S. Cl. 525/240

(57) ABSTRACT

A polymer composition comprises (a) greater than 50 wt % (based upon the weight of the composition) of a cyclic olefin copolymer comprising at least one acyclic olefin and at least 20 weight % of one or more cyclic olefins (based upon the weight of the cyclic olefin copolymer), wherein at least a portion of the cyclic olefin copolymer has a glass transition temperature of greater than 150° C.; and (b) less than 50 wt % (based upon the weight of the composition) of an acyclic olefin polymer modifier, at least a portion of the modifier having a glass transition temperature of less than −30° C.; and no portion of the modifier having a softening point greater than +30° C., wherein the Bicerano solubility parameter of the modifier being no more than 0.6 J^{0.5}/cm^{1.5} less than the Bicerano solubility parameter of the cyclic olefin copolymer. The polymer composition has a notched Izod impact resistance measured at 23° C. of greater than 500 J/m and a heat distortion temperature measured using a 0.46 MPa load of greater than 135° C.

### CROSS REFERENCE TO RELATED APPLICATIONS

This application claims priority to U.S. Provisional Patent Application No. 60/835,524, filed Aug. 4, 2006 and U.S. Provisional Patent Application No. 60/836,007, filed Aug. 7, 2006, the disclosures of which are incorporated by reference.

### FIELD OF THE INVENTION

The present invention relates to polymer compositions comprising cyclic olefin copolymers and polyolefin modifiers.

### BACKGROUND OF THE INVENTION

Cyclic olefin copolymers have high glass transition temperatures and high stiffness, however, they suffer from very poor impact properties and are too brittle for many applications. Numerous attempts have been made to improve their impact properties by blending with modifiers of many types, and their stiffness by blending with reinforcements. None of these previous attempts has been very successful, and for the most part, cyclic olefin copolymers have been relegated to applications taking advantage of only their optical clarity, moisture resistance, and good birefringence properties.

Polyolefins, and in particular those of the polyethylene and polypropylene groups, are low-cost, lower-density thermoplastics which melt readily and are resistant to chemicals. These materials therefore have many uses in areas such as general household items and electrical and electronic parts. However, polyolefins usually have poor mechanical properties and relatively low heat distortion temperatures (HDT). For example, a typical polypropylene homopolymer has a flexural modulus of about 1.9 GPa, a heat distortion temperature at 0.46 MPa of about 126° C., and a notched Izod impact resistance of about 48 J/m. These plastics are therefore unsuitable for use in areas which require high heat resistance, high mechanical strength, and/or high impact resistance.

To improve their impact resistance, polypropylene homopolymers are often blended with ethylene-propylene rubber (EPR) or ethylene-propylene-diene (EPDM) rubber. EPR and EPDM rubbers are used for impact modification, because they remain ductile until their glass transition temperatures at about −45° C. and effectively toughen polypropylene even at −29° C., a common testing temperature. EPR, EPDM, and polypropylene have similar polarities, so small rubber domains can be well dispersed in the polypropylene. Impact resistance can also be improved by copolymerizing the propylene with a few percent of ethylene to make impact copolymers. However, these improved impact properties come with decreased modulus and lowered heat distortion temperatures. Thus, a typical polypropylene impact copolymer containing EPR has flexural modulus of about 1.0 GPa, a heat distortion temperature at 0.46 MPa of about 92° C., a room temperature notched Izod impact strength so high that no test samples break (approx. 500 J/m or more), and generally has only ductile failures in the instrumented impact test at −29° C. (approx. 43 J of energy adsorbed).

To achieve more balanced properties, polypropylenes can be blended with both ethylene-propylene or ethylene-propylene-diene elastomers and inorganic fillers such as talc, mica, or glass fibers. Talc and mica reinforcements are generally preferred to glass fibers, because the compounded polymers have better surface and flow properties. An example of these materials is ExxonMobil's AS65 KW-1ATM, which has a flexural modulus of about 2.4 GPa, a heat distortion temperature at 0.46 MPa of about 124° C. and a notched Izod Impact of about 400 J/m. These polymer blends have a good balance of properties and are used in automotive interior applications. However, these blends can not be used for some automotive structural applications, where useful materials need heat distortion temperatures at 0.46 MPa of at least 140° C. and at 1.80 MPa of at least 120° C., together with a modulus of at least 2.5 GPa and a room temperature notched Izod impact of at least 100 J/m.

In an attempt to achieve balanced properties that exceed those of blended polypropylenes, blends of cyclic olefin copolymers with polyolefins have also been proposed. Copolymers of ethylene with norbornene and with 2,3-dihydrodicyclopentadiene are disclosed in U.S. Pat. No. 2,799,668 (Jul. 16, 1957) and U.S. Pat. No. 2,883,372 (Apr. 21, 1959). However, these polymers use TiCl₄ as the catalyst and are polymerized by ring opening metathesis—the cyclic olefin rings are opened during copolymerizations with ethylene, leaving a residual double bond in the backbone of the polymer. Because the rings open, the chains are less rigid than addition polymerization cyclic olefin copolymers. The residual unsaturation in their backbones also make these polymers oxidatively unstable at high temperatures. Consequently, although these copolymers have desirable rigidity and transparency, they are poor in heat resistance.

U.S. Pat. No. 3,494,897 discloses a high pressure, peroxide initiated, radical copolymerization to make ethylene/cyclic olefin copolymers but these polymerizations can only incorporate small amounts of the cyclic olefins. As a result, the polymers do not have high glass transition temperatures.

Several blends of ethylene/norbornene copolymers with polyolefins were described by researchers at VEB Leuna-Werke in the early 1980s (DE 2731445 C3, DD 150751, DD 203061, DD 203059, DD 203062, DD 205916, DD 206783, DD 209840, DD 214851, DD 214849, and DD 214850). However, these blends were made before the discovery of either the Ziegler-Natta vanadium/aluminum or metallocene addition polymerization catalysts. The ethylene/norbornene copolymers used in these blends were made with catalysts that open cyclic rings during polymerization and lead to residual unsaturation in the polymer backbones. The Vicat softening temperatures exemplified in these patents range from 114 to 133° C. indicating that these polymers do not have the heat stability required for automotive structural applications. In this respect, it is to be appreciated that Vicat softening temperatures are generally about 10° C. higher than the glass transition temperature of a glassy polymer, whereas the glass transition temperature of a glassy polymer is generally about 10° C. higher than its heat distortion temperature at 0.46 MPa. Thus Vicat softening temperatures from 114 to 133° C. are roughly equivalent to heat distortion temperatures of about 94 to 113° C. using the 0.46 MPa load.

U.S. Pat. No. 4,614,778 discloses a random copolymer of ethylene with a 1,4,5,8-dimethano-1,2,3,4,4a,5,8,8a-octahydronaphthalene and optionally an alpha-olefin having at least three carbon atoms or a cycloolefin, such as norbornene. The mole ratio of polymerized units from the 1,4,5,8-dimethano-1,2,3,4,4a,5,8,8a-octahydronaphthalene to polymerized units from ethylene is from 3:97 to 95:5 and the 1,4,5,8-dimethano-1,2,3,4,4a,5,8,8a-octahydronaphthalene is incorporated in the ethylene polymer chain using a Ziegler-Natta vanadium/aluminum catalyst. The cyclic olefin rings do not open during copolymerization, and the resultant copolymers contain no residual unsaturation in their backbone. Thus, these copolymers have high heat distortion temperatures and glass transition temperatures as high as 171° C. However, the copolymers are quite brittle, when pressed into films, and all are copolymers of ethylene and cyclic olefin comonomers containing at least four fused rings. The disadvantage of these larger comonomers is that extra Diels-Alder addition reactions are required to build them up from ethylene and cyclopentadiene, making them more expensive to synthesize than norbornene or dicyclopentadiene. No blends are exemplified in this patent.

U.S. Pat. No. 5,087,677 describes the copolymerization of ethylene and cyclic olefins, particularly norbornene, using zirconium and hafnium metallocene catalysts. Like the vanadium/aluminum polymerized copolymers described in U.S. Pat. No. 4,614,778, the metallocene polymerized copolymers do not have residual unsaturation in their backbones and the cyclic olefins do not ring open. Consequently, these metallocene ethylene/cyclic olefin copolymers have high heat stabilities and glass transition temperatures, with values as high as 163° C. for the glass transition temperature being exemplified. There is brief mention, but no exemplification, of alloying the copolymers with other polymers, such as polyethylene, polypropylene, (ethylene/propylene) copolymers, polybutylene, poly-(4-methyl-1-pentene), polyisoprene, polyisobutylene, and natural rubber.

U.S. Pat. No. 4,918,133 discloses a cycloolefin type random copolymer composition, which is alleged to exhibit excellent heat resistance, chemical resistance, rigidity, and impact resistance, and which comprises (A) a random copolymer containing an ethylene component and a cycloolefin component and having an intrinsic viscosity [η] of 0.05-10 dl/g as measured at 135° C. in decalin and a softening temperature (TMA) of not lower than 70° C., and (B) one or more non-rigid copolymers selected from the group consisting of: (i) a random copolymer containing an ethylene component, at least one other α-olefin component and a cycloolefin component and having an intrinsic viscosity [η] of 0.01-10 dl/g as measured at 135° C. in decalin and a softening temperature (TMA) of below 70° C., (ii) a non-crystalline to low crystalline e-olefin type elastomeric copolymer formed from at least two α-olefins, (iii) an α-olefin-diene type elastomeric copolymer formed from at least two α-olefins and at least one non-conjugated diene, and (iv) an aromatic vinyl type hydrocarbon-conjugated diene copolymer or a hydrogenated product thereof, and optionally (c) an inorganic filler or organic filler. The cycloolefin component of the copolymer (A) can be a large number of 1 to 4-ring bridged cyclic olefins and, although these include norbornene, the only material exemplified is 1,4,5,8-dimethano-1,2,3,4,4a,5,8,8a-octahydronaphthalene (DMON) and a methyl-substituted version thereof.

U.S. Pat. No. 6,255,396 discloses a polymer blend useful for fabrication into transparent articles for medical applications and comprising 1-99% by weight of a first component obtained by copolymerizing a norbornene monomer and an ethylene monomer, and 99% to 1% by weight of a second component comprising an ethylene copolymer with an α-olefin having 6 carbon atoms. The first component has a glass transition temperature of from 50° C. to 180° C., but the second blend component has a softening points above 30° C. due to either its melting point (softening temperatures are slightly below the melting point) or its glass transition temperatures (softening point is typically about 10° C. above T_{g}). No measurements of flexural modulus or impact strength are reported in the patent and no inorganic fillers are exemplified.

U.S. Pat. No. 6,590,033 discloses a polymer blend similar to that described in U.S. Pat. No. 6,255,396 but with the second component comprising a homopolymer or copolymer of a diene having from 4 to 12 carbons. Such diene polymers typically have softening points above 30° C. or solubility parameters that are too different from those of the cyclic olefin copolymers to be compatible. For example, the Bicerano solubility parameter for poly(1,4-butadiene) is 17.7 J^{0.5}/cm^{1.5} compared with 16.88 J^{0.5}/cm^{1.5} for the cyclic olefin copolymers. (Values are from Table 5.2 in Prediction of Polymer Properties, 3^{rd} edition by Jozef Bicerano published by Marcel Dekker in 2002.) In addition, poly(1,4-butadiene) is too polar to be effective at toughening cyclic olefin copolymers.

U.S. Pat. No. 6,844,059 discloses long-fiber-reinforced polyolefin structure of length ≧3 mm, which comprises a) from 0.1 to 90% by weight of at least one polyolefin other than b), b) from 0.1 to 50% by weight of at least one amorphous cycloolefin polymer, such as an ethylene/norbornenes copolymer, c) from 5.0 to 75% by weight of at least one reinforcing fiber, and d) up to 10.0% by weight of other additives. The polyolefin a) may be obtained by addition polymerization of ethylene or of an α-olefin, such as propylene, using a suitable catalyst and generally is a semi-crystalline homopolymer of an α-olefin and/or ethylene, or a copolymer of these with one another.

In Die Angewandte Makromolekulare Chemie 256 (1998), pp. 101-104, Stricker and Mulhaupt describe blends of an ethylene/norbornene copolymer containing only 40 wt. % norbornene The thermal stability of this copolymer is not reported, however the glass transition temperature can be estimated at less than 60° C. The rubber used to toughen the cyclic olefin copolymer is an polystyrene-b-poly(ethylene-co-butylene)-b-polystyrene (SEBS) copolymer. Polystyrene blocks in this copolymer have glass transition temperatures in the range 83-100° C., giving this modifier a softening temperature of more than 80° C.

In an article entitled “Rubber Toughened and Optically Transparent Blends of Cyclic Olefin Copolymers” in Polymer Engineering and Science, Vol. 40(12), p. 2590-2601, December, 2000, Khanarian describes unfilled blends of the ethylene/norbornene copolymer TOPAS 6013 with thermoplastic elastomers such as styrene-butadiene-styrene (SBS), styrene-ethylene-butadiene-styrene (SEBS), and styrene-ethylene-propylene-styrene (SEPS). The TOPAS 6013 has a glass transition temperature of 140° C. and it is reported that blending with less than 5 wt % of the elastomer allows the impact strength to be increased to greater than 50 J/m (Notched Izod) while keeping the optical haze below 5%. Using high loadings of the styrenic block copolymers, Khanarian achieves a notched Izod impact strengths as high as 520 J/m with 30 wt. % polystyrene-b-polybutadiene-b-polystyrene. This modifier has a softening point above 30° C. due to the glass transition temperature of the polystyrene blocks. Khanarian also exemplifies some blends with ethylene-propylene-diene terpolymers, but the impact strength reported is only 188 J/m with a 20 wt. % loading. Measured heat distortion temperatures are not presented in this paper but, given the low glass transition temperature of the TOPAS 6013, are probably less than 125° C. at 0.46 MPa.

Other references of interest include U.S. Pat. No. 4,874,808; U.S. Pat. No. 4,992,511; U.S. Pat. No. 5,428,098; U.S. Pat. No. 5,359,001; U.S. Pat. No. 5,574,100; U.S. Pat. No. 5,753,755; U.S. Pat. No. 5,854,349; U.S. Pat. No. 5,863,986; U.S. Pat. No. 6,090,888; U.S. Pat. No. 6,225,407; US 2003/0125464 A1; U.S. Pat. No. 6,596,810 B1; U.S. Pat. No. 6,696,524 B2; U.S. Pat. No. 6,767,966 B2; US 2004/0236024 A1; and US 2005/0014898 A1.

According to the invention, it has now been found that combining high glass transition temperature cyclic olefin copolymers with compatible, low glass transition temperature polyolefin elastomers can produce polymer compositions having a desirable combination of high stiffness, impact toughness, and thermal stability making the blends suitable for use in automotive structural applications.

### SUMMARY OF THE INVENTION

In one aspect, the invention resides in a polymer composition comprising:
(a) greater than 50 wt % (based upon the weight of the composition) of a cyclic olefin copolymer, said cyclic olefin copolymer comprising at least one acyclic olefin and at least 20 weight % of one or more cyclic olefins (based upon the weight of the cyclic olefin copolymer), wherein at least a portion of said cyclic olefin copolymer has a glass transition temperature of greater than 150° C.;
(b) less than 50 wt % (based upon the weight of the composition) of an acyclic olefin polymer modifier, at least a portion of the modifier having a glass transition temperature of less than −30° C.; and no portion of the modifier having a softening point greater than +30° C., the Bicerano solubility parameter of the modifier being no more than 0.6 J^{0.5}/cm^{1.5} less than the Bicerano solubility parameter of the cyclic olefin copolymer;
   wherein the notched Izod impact resistance of the composition measured at 23° C. is greater than 500 J/m and the heat distortion temperature of the composition measured using a 0.46 MPa load is greater than 135° C.

Conveniently, said cyclic olefin copolymer comprises at least 30 weight %, such as at least 40 weight %, of one or more cyclic olefins.

Conveniently, at least a portion of said cyclic olefin copolymer has a glass transition temperature of greater than 160° C., even greater than 170° C. In one embodiment all of said cyclic olefin copolymer has a glass transition temperature of greater than 150° C.

Conveniently, at least a portion of the polymer modifier has a glass transition temperature of less than −40° C., such as less than −50° C. In one embodiment, all of said polymer modifier has a glass transition temperature of less than −30° C. Conveniently, no portion of the modifier has a softening point greater than +10° C.

Conveniently, the Bicerano solubility parameter of the modifier is between about 0.1 and about 0.5 J^{0.5}/cm^{1.5}, such as between about 0.2 and about 0.4 J^{0.5}/cm^{1.5}, less than the Bicerano solubility parameter of the cyclic olefin copolymer.

Conveniently, the polymer composition has a notched Izod impact resistance measured at 23° C. of greater than 550 J/m, for example greater than 600 J/m, even greater than 700 J/m; a notched Izod impact resistance measured at −18° C. greater than 50 J/m. such as greater than 150 J/m, for example greater than 300 J/m, even greater than 500 J/m; an instrumented impact energy measured at 23° C. of greater than 25 J, such as greater than 30 J; an instrumented impact energy measured at −29° C. of greater than 25 J, such as greater than 30 J; a heat distortion temperature measured using a 0.46 MPa load of greater than 150° C., such as greater than 165° C.; a heat distortion temperature measured using a 1.80 MPa load of greater than 115° C., such as greater than 130° C., for example greater than 145° C.; and a flexural modulus (1% secant method) of greater than 1200 MPa, such as greater than 2000 MPa, for example greater than 2500 MPa.

### BRIEF DESCRIPTION OF THE DRAWINGS

FIG. 1 is a graph showing the effect of different elastomers on the room temperature Izod impact of compression molded blends of Topas 6015 containing 20 wt. % elastomer.

FIG. 2 is a graph showing the effect of compatibility between the cyclic olefin copolymer and the modifier on the room temperature Izod impact of compression molded specimens produced from blends of Topas 6015 with 20 wt. % of various modifiers.

FIG. 3 is a graph showing the effect of various modifiers on the room temperature Izod impact of injection molded blends of Topas 6015 containing 20 wt. % modifiers.

FIG. 4 is a graph showing the effect of compatibility between the cyclic olefin copolymer and the modifiers on the room temperature Izod impact resistance of injection molded Topas 6015 blends, containing 20 wt. % of modifiers.

FIG. 5 is a graph showing the effect of modifier loading on the room temperature notched Izod impact resistance of Topas 6015/Vistalon 8600 blends.

FIG. 6 is a graph comparing the properties of a commercial high impact polypropylene with unfilled high impact ethylene/norbornene copolymer blends of the invention.

FIG. 7 is a graph showing the decrease in the flexural modulus (1% Secant) of unfilled Topas 6015/Vistalon 8600 blends, as more modifier is added to the blends.

### DETAILED DESCRIPTION OF THE EMBODIMENTS

When a polymer or oligomer is referred to as comprising an olefin, the olefin present in the polymer or oligomer is the polymerized or oligomerized form of the olefin, respectively. The term polymer is meant to encompass homopolymers and copolymers. The term copolymer includes any polymer having two or more different monomers in the same chain, and encompasses random copolymers, statistical copolymers, interpolymers, and (true) block copolymers.

The present invention provides a polymer composition comprising:
(a) greater than 50 wt %, for example about 60 wt % to about 80 wt %, such as about 65 wt % to about 75 wt %, (based upon the weight of the composition) of a cyclic olefin first copolymer at least a portion of which has a glass transition temperature of greater than 150° C.; and
(b) less than 50 wt %, for example about 20 wt % to about 40 wt %, such as about 25 wt % to about 35 wt %, (based upon the weight of the composition) of a compatible acyclic olefin second polymer modifier, at least a portion of the second polymer having a glass transition temperature of less than −30° C.; and no portion of the second copolymer having a softening point greater than +30° C.

The blend has a notched Izod impact resistance measured at 23° C. of greater than 500 J/m and a heat distortion temperature measured using a 0.46 MPa load of greater than 135° C. making the blend highly suitable for use in automotive structural applications.

### Cyclic Olefin First Copolymer

The cyclic olefin first copolymer component of the present polymer composition is produced by copolymerizing at least one cyclic olefin with at least one acyclic olefin and possibly one or more dienes. The total of amount of all the cyclic olefins in the first copolymer is from about 20 to about 99 weight % of the copolymer. The residual double bonds in cyclic olefin copolymers may not have reacted or may have been hydrogenated, crosslinked, or functionalized. Cyclic olefin copolymers may have been grafted using free radical addition reactions or in-reactor copolymerizations. They may be block copolymers made using chain shuttling agents.

Cyclic olefins are defined herein as olefins where at least one double bond is contained in one or more alicyclic rings. Cyclic olefins may also have acyclic double bonds in side chains. Suitable cyclic olefins for use in cyclic olefin copolymer component include norbornene, tricyclodecene, dicyclopentadiene, tetracyclododecene, hexacycloheptadecene, tricycloundecene, pentacyclohexadecene, ethylidene norbornene (ENB), vinyl norbornene (VNB), norbornadiene, alkylnorbornenes, cyclopentene, cyclopropene, cyclobutene, cyclohexene, cyclopentadiene (CP), cyclohexadiene, cyclooctatriene, indene, any Diels-Alder adduct of cyclopentadiene and an acyclic olefin, cyclic olefin, or diene; and any Diels-Alder adduct of butadiene and an acyclic olefin, cyclic olefin, or diene; vinylcyclohexene (VCH); alkyl derivatives of cyclic olefins; and aromatic derivatives of cyclic olefins.

Suitable acyclic olefins for use in cyclic olefin copolymer component include alpha olefins (1-alkenes), isobutene, 2-butene, and vinylaromatics. Examples of such acyclic olefins are ethylene, propylene, 1-butene, isobutene, 2-butene, 1-pentene, 1-hexene, 1-heptene, 1-octene, 1-nonene, 1-decene, styrene, p-methylstyrene, p-t-butylstyrene, p-phenylstryene, 3-methyl-1-pentene, vinylcyclohexane, 4-methyl-1-pentene, alkyl derivatives of acyclic olefins, and aromatic derivatives of acyclic olefins.

Dienes are defined herein broadly as including any olefin containing at least two acyclic double bonds. They may also contain aromatic substituents. If one or more of the double bonds of diene is contained in an alicyclic ring, the monomer is classified as a cyclic olefin in this invention. Suitable dienes for use in the cyclic olefin copolymer component are 1,4-hexadiene; 1,5-hexadiene; 1,5-heptadiene; 1,6-heptadiene; 1,6-octadiene; 1,7-octadiene; 1,9-decadiene; butadiene; 1,3-pentadiene; isoprene; 1,3-hexadiene; 1,4-pentadiene; p-divinylbenzene; alkyl derivatives of dienes; and aromatic derivatives of dienes.

Suitable cyclic olefin copolymers for use as the first copolymer component of the present composition include ethylene-norbornene copolymers; ethylene-dicyclopentadiene copolymers; ethylene-norbornene-dicyclopentadiene terpolymers; ethylene-norbornene-ethylidene norbornene terpolymers; ethylene-norbornene-vinylnorbornene terpolymers; ethylene-norbornene-1,7-octadiene terpolymers; ethylene-cyclopentene copolymers; ethylene-indene copolymers; ethylene-tetracyclododecene copolymers; ethylene-norbornene-vinylcyclohexene terpolymers; ethylene-norbornene-7-methyl-1,6-octadiene terpolymers; propylene-norbornene copolymers; propylene-dicyclopentadiene copolymers; ethylene-norbornene-styrene terpolymers; ethylene-norbornene-p-methylstyrene terpolymers; functionalized ethylene-dicyclopentadiene copolymers; functionalized propylene-dicyclopentadiene copolymers; functionalized ethylene-norbornene-diene copolymers; maleic anhydride grafted cyclic olefin copolymers; silane grafted cyclic olefin copolymers; hydrogenated ethylene-dicyclopentadiene copolymers; epoxidized ethylene-dicyclopentadiene copolymers; epoxidized ethylene-norbornene-dicyclopentadiene terpolymers; grafted cyclic olefin copolymers; short chain branched cyclic olefin copolymers; long chain branched cyclic olefin copolymers; and crosslinked cyclic olefin copolymers.

Cyclic olefin copolymers containing norbornene or hydrogenated dicyclopentadiene are particularly preferred. Norbornene is made from the Diels-Alder addition of cyclopentadiene and ethylene. (Cyclopentadiene is made commercially by a reverse Diels-Alder reaction starting with dicyclopentadiene). Dicyclopentadiene is a byproduct of cracking heavy feedstocks to make ethylene and propylene. Other preferred cyclic olefins are Diels-Alder adducts of cyclopentadiene with other olefins, leading to alkyl- or aryl-norbornenes, or with butadiene leading to vinylnorbornene and ethylidene norbornene. The Diels-Alder adduct of butadiene with itself leads to vinylcyclohexene, which is another preferred monomer. A preferred acyclic olefin for cyclic olefin copolymers is ethylene since ethylene-cyclic olefin copolymers have slightly better impact properties than other copolymers. Terpolymers of ethylene with norbornene and dienes containing a double bond in alicyclic rings are also preferred, because they can easily be crosslinked, grafted, or functionalized.

At least a portion of the cyclic olefin copolymer employed in the first copolymer component of the present composition has a glass transition temperatures greater than 150° C. These high glass transition temperature domains will start softening about 10-30° C. below the glass transition temperature and lead to heat distortion temperatures using a 0.45 MPa load of about 10-15° C. below their glass transition temperature and to heat distortion temperatures using a 1.80 MPa load of about 30-35° C. below the glass transition temperature. It is preferred that the glass transition temperature of at least a portion of these cyclic olefin copolymers is greater than 160° C. and more preferably is greater than 170° C. If only a portion of the cyclic olefin copolymers has a glass transition temperature greater than 150° C., it is preferable that the remaining portion has a softening point below 30° C. Such a cyclic olefin copolymer might be a block or graft copolymer with an elastomer. If a portion of the cyclic olefin copolymer has a softening point above 30° C. and below the softening point associated with the glass transition temperature above 150° C., it will tend to lower the heat distortion temperature and high temperature modulus of the composition. Cyclic olefin copolymers where all the domains have glass transition temperatures greater than 100° C. are preferred.

For automotive applications, where the present composition is to be injection molded, it is also preferred for the cyclic olefin copolymers to have high melt flow rates when measured at the processing temperatures of the injection molding machine. Melt flow rates greater than 5 ml/10 min. in the ISO 1133 test at 115° C. above the heat distortion temperature using the 1.80 MPa load are preferred.

Useful ethylene-norbornene copolymers are can be purchased from Topas Advanced Polymers and Mitsui Chemicals. Ethylene/norbornene copolymers made with metallocene catalysts are available commercially from Topas Advanced Polymers GmbH, as TOPAS copolymers. TOPAS grades 6015 and 6017 are reported to have glass transition temperatures of 160 and 180° C., respectively. Their reported heat distortion temperatures at 0.46 MPa (150 and 170° C., respectively) and at 1.80 MPa (135 and 151° C., respectively) can provide polymer compositions meeting the preferred heat distortion temperature of at least 130° C. at 0.46 MPa.

Useful cyclic-olefin copolymers can be made using vanadium, Ziegler-Natta, and metallocene catalysts. Examples of suitable catalysts are disclosed in U.S. Pat. Nos. 4,614,778 and 5,087,677.

### Acyclic Olefin Second Polymer

The second polymer component of the present composition comprises one or more random, blocky, or block polymers. Each of the polymers is polymerized from at least one olefin and, possibly, at least one diene. The olefins can be either acyclic or cyclic olefins, as long as the total amount of cyclic olefin in the copolymer is less than 20 weight %. The residual double bonds in the polyolefin modifiers may not have been reacted or may have been hydrogenated, functionalized, or crosslinked. The polyolefin modifiers may have been grafted using free radical addition reactions or in-reactor copolymerizations. They may be block copolymers made using chain shuttling agents.

Acyclic olefins suitable for use in the second polymer component include alpha olefins (1-alkenes), isobutene, 2-butene, and vinylaromatics. Examples of such acyclic olefins are ethylene, propylene, 1-butene, isobutene, 2-butene, 1-pentene, 1-hexene, 1-heptene, 1-octene, 1-nonene, 1-decene, styrene, p-methylstyrene, p-t-butylstyrene, p-phenylstryene, 3-methyl-1-pentene, vinylcyclohexane, 4-methyl-1-pentene, alkyl derivatives of acyclic olefins, and aromatic derivatives of acyclic olefins.

Cyclic olefins suitable for use in the second polymer component include norbornene, tricyclodecene, dicyclopentadiene, tetracyclododecene, hexacycloheptadecene, tricycloundecene, pentacyclohexadecene, ethylidene norbornene (ENB), vinyl norbornene (VNB), norbornadiene, alkylnorbornenes, cyclopentene, cyclopropene, cyclobutene, cyclohexene, cyclopentadiene (CP), cyclohexadiene, cyclooctatriene, indene, any Diels-Alder adduct of cyclopentadiene and an acyclic olefin, cyclic olefin, or diene; and Diels-Alder adduct of butadiene and an acyclic olefin, cyclic olefin, or diene; vinylcyclohexene (VCH); alkyl derivatives of cyclic olefins; and aromatic derivatives of cyclic olefins.

Dienes suitable for use in the second polymer component include 1,4-hexadiene; 1,5-hexadiene; 1,5-heptadiene; 1,6-heptadiene; 1,6-octadiene; 1,7-octadiene; 1,9-decadiene; butadiene; 1,3-pentadiene; isoprene; 1,3-hexadiene; 1,4-pentadiene; p-divinylbenzene; alkyl derivatives of dienes; and aromatic derivatives of dienes.

Suitable acyclic olefin copolymers for use as the second polymer component of the present composition include high density polyethylene (HDPE); low density polyethylene (LDPE); linear low density polyethylene (LLDPE); isotactic polypropylene (iPP); atactic polypropylene (aPP); syndiotactic polypropylene (sPP); poly(1-butene); poly(isobutylene); butyl rubber; poly(butadiene); poly(3-methyl-1-pentene); poly(4-methyl-1-pentene); poly(1-hexene); semi-crystalline ethylene-propylene copolymers; amorphous ethylene-propylene copolymers; semi-crystalline propylene-ethylene copolymers; semi-crystalline copolymers of ethylene with alpha olefins; semi-crystalline copolymers of ethylene with isobutylene or 2-butene; semi-crystalline copolymers of ethylene with vinylaromatics; semi-crystalline copolymers of ethylene with dienes such as hexadiene, vinylcyclohexene, and 7-methyl-1,6-octadiene; semi-crystalline copolymers of propylene with alpha olefins; semi-crystalline copolymers of propylene with vinyl aromatics; semi-crystalline copolymers of propylene with vinyl aromatics; semi-crystalline copolymers of propylene with isobutene or 2-butene; semi-crystalline copolymers of propylene with dienes; in reactor blends of isotactic polypropylene with ethylene-propylene rubber or ethylene-propylene-diene terpolymers (ICPs); amorphous ethylene copolymers with alpha olefins, vinyl aromatics, cyclic olefins, isobutene, 2-butene, or dienes; terpolymers of ethylene, alpha olefins including propylene, and dienes; terpolymers of ethylene, alpha olefins, and vinyl aromatics; terpolymers of ethylene, alpha olefins, and cyclic olefins; polyolefins grafted to polystyrene; polyolefins grafted to cyclic olefin copolymers; polyolefins grafted to other polyolefins; terpolymers of propylene, another olefin, and dienes; amorphous copolymers of isobutene with isoprene; amorphous copolymers of isobutene and p-methylstyrene; polyolefins with double bonds that have been hydrogenated; polyolefins with double bonds that have been epoxidized or hydroxylated; polyolefins with double bonds that have been functionalized by electrophilic additions; any functionalized polyolefin; polyolefins with short and long chain branches, polyolefins which have been crosslinked through their double bonds; polyolefins which have been crosslinked through functional groups; and polyolefins that have been grafted using free radical addition reactions. Preferred second copolymers include ethylene propylene rubbers (EP rubbers). The term “EP rubber” means a copolymer of ethylene and propylene, and optionally one or more diene monomer(s)(as described above), where the ethylene content is from 25 to 80 wt %, the total diene content is up to 15 wt %, and the balance is propylene.

At least a portion of the second polymer component should have a glass transition temperature below −30° C. These low glass transition temperature domains of the modifier remain ductile down to their glass transition temperatures and improve the low temperature notched Izod impact resistance and low temperature instrumented impact energy to the present composition. Preferably, the glass transition temperature of at least a portion of the polyolefin modifier is less than −40° C., more preferably less than −50° C. Preferably, all portions of the polyolefin modifier have these low glass transition temperatures and are available to toughen the brittle cyclic olefin copolymer phases.

In addition, the second polymer component should contain no portion with a softening point above 30° C., and preferably, above 10° C. A softening point above 30° C. is due to a glass transition temperature above 30° C. or a melting temperature of a significant portion of the modifier above 30° C. They are detectable as transitions or peaks in a differential scanning calorimeter (DSC), a Vicat softening point, a softening point in a thermal mechanical analyzer (TMA), or a sudden loss of modulus of the polyolefin modifier in a differential mechanical thermal analysis (DMTA) experiment. They are undesirable because the softening modifier also leads to a detectable softening and a lowered high temperature modulus for the composition.

The cyclic olefin first copolymer used in present composition has a very high glass transition temperature and must, therefore, be processed at even higher temperatures. The second polymer modifier used in the composition must be stable at these high processing temperatures. It is therefore preferred that the modifier contains one or more anti-oxidants effective at stabilizing the modifier at these high processing temperatures. It is also preferred that the modifier contains a UV stabilizer to prevent damage during end use applications. Most preferred are polyolefin modifiers that contain no groups that are reactive at the processing temperatures used to blend and form the present compositions.

In order for the second polymer modifier to effectively toughen the brittle cyclic first copolymer, it is desirable that the domain size of the second copolymer is less than 1-2 μm, more preferably less than 1.0 μm, in average diameter. These small domains can be achieved, when the interfacial energy between the second polymer and the brittle cyclic olefin copolymer is very small, or is even zero. Minimal interfacial energy between two phases means that breaking a large domain up into smaller domains with more interfacial area is thermodynamically allowed. Compositions with very small or zero interfacial energies can be effectively mixed, and the polyolefin modifiers dispersed, by applying shear to the melted mixture. In order to achieve toughening for a cyclic olefin copolymer, the polyolefin modifier preferably has a zero or low interfacial energy with the first copolymer. According to Souheng Wu in Polymer Interface and Adhesion, Marcel Dekker, 1982, zero or low interfacial energies are achieved when the polarity of the polyolefin modifier and cyclic olefin copolymer are matched.

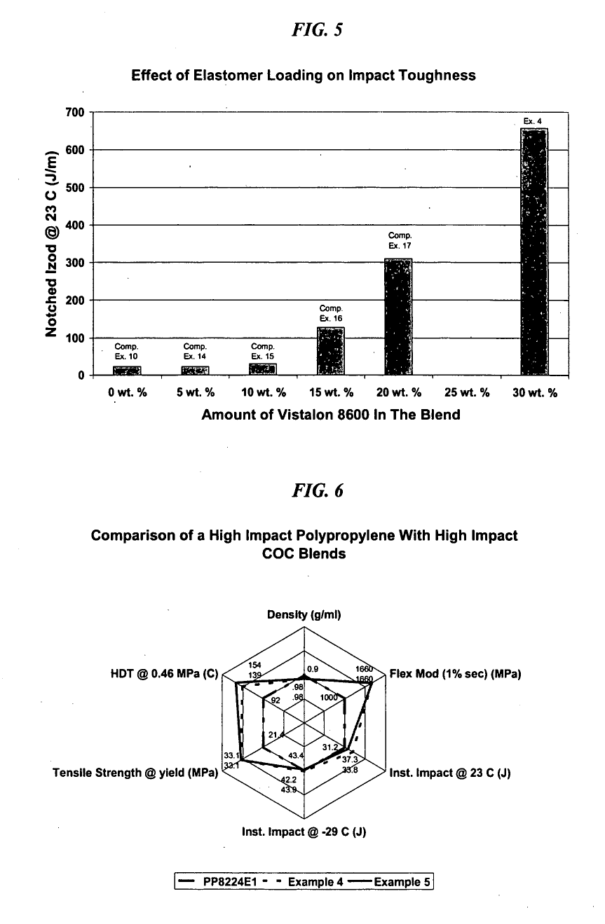

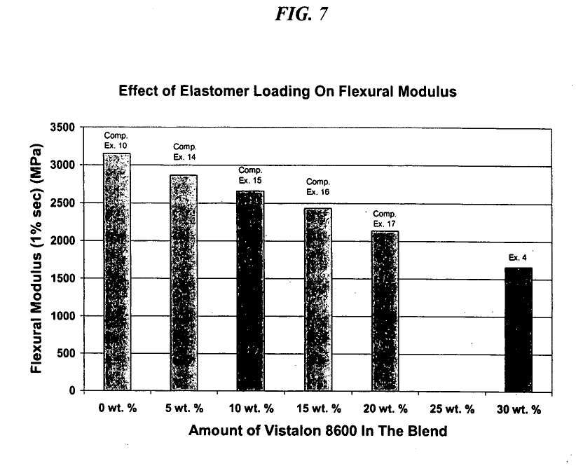

To match the polarities experimentally, surface energies or solubility parameters need to be measured for each polyolefin modifier and each cyclic olefin copolymer. Surprisingly, it has been found that determining Bicerano solubility parameters can quickly narrow the candidate polyolefin modifiers for a given target cyclic olefin copolymer. D. W. Van Krevelen in Properties of Polymers, Their Correlation With Chemical Structure; Their Numerical Estimation and Prediction From Additive Group Contributions, Elsevier, 1990 developed correlations between the functional groups present in a polymer chain and its experimental solubility parameter. These correlations worked fairly well but were limited to the set of polymers containing only the functional groups used in the original correlations. Jozef Bicerano extended these correlations in Prediction of Polymer Properties, 3^{rd} Edition, Marcel Dekker, 2002, by replacing correlations with functional groups with correlations with graph theory indices. Graph theory indices depend only on how the polymer repeat units are bonded together and on the elements present in the repeat units. They can be calculated for any repeat unit and correlated well with solubility parameters. Bicerano has tabulated Bicerano solubility parameters for 121 common polymers in Table 5.2 of his book. These equations have also been programmed into the Synthia module of the Cerius² molecular modeling software package available from Accelerys. Using these Bicerano solubility parameters for both the cyclic olefin copolymers and polyolefin modifiers used in the ensuing Examples, the compositions with the highest room temperature notched Izod impact resistance always occur when the Bicerano solubility parameter of the polyolefin modifiers are between 0.0 and 0.6 J^{0.5}/cm^{1.5} less than the Bicerano solubility parameters of the cyclic olefin copolymers. See FIGS. 2 and 4 for plots of room temperature notched Izod impact resistance versus differences in Bicerano solubility parameters (indicated as Est. Sol. Param.). Preferably, the Bicerano solubility parameter of the polyolefin modifier is between 0.1-0.5 J^{0.5}/cm^{1.5}, more preferably between 0.2-0.4 J^{0.5}/cm^{1.5}, less than the Bicerano solubility parameter of the cyclic olefin copolymer.

Preferred polyolefins can be purchased from ExxonMobil Chemical Company under the trade names Vistalon, Exxelor, Exact, or Vistamaxx, or they may be polymerized using vanadium, Ziegler-Natta, or metallocene catalysts by methods well known in the art.

Preferred EP rubbers useful as the second polymer in the compositions described herein include those having one or more of the following properties:
1) ethylene content of 25 to 80 wt % (preferably 30 to 75 wt %, preferably 35 to 70 wt %, preferably 40 to 65 wt %); and/or
2) diene content of 15 wt % or less, (preferably 12 wt % or less, preferably 9 wt % or less, preferably 6 wt % or less, preferably 3 wt % or less, preferably 0 wt %); and/or
3) density of 0.87 g/cm³ or less (preferably 0.865 g/cm³ or less, preferably 0.86 g/cm³ or less, preferably 0.855 g/cm³ or less); and/or
4) heat of fusion (H_{f}), if detected, of less than 20 J/g (preferably less than 15 J/g, preferably less than 10 J/g, preferably less than 5 J/g, preferably a heat of fusion is indiscernible); and/or
5) ethylene or propylene crystallinity, if measurable, of less than 10 wt % (preferably less than 7.5 wt %, preferably less than 5 wt %, preferably less than 2.5 wt %, preferably crystallinity is undetected); and/or
6) melting point (Tₘ, peak first melt), if detected, of 60° C. or less (preferably 50° C. or less, preferably 40° C. or less, preferably 35° C. or less); and/or
7) glass transition temperature (T_{g}) of −30° C. or less (preferably −40° C. or less, preferably −50° C. or less, preferably −60° C. or less); and/or
8) M_{w} of 50 to 3,000 kg/mol (preferably 100 to 2,000 kg/mol, preferably 200 to 1,000 kg/mol); and/or
9) M_{w}/Mₙ of 1.5 to 40 (preferably 1.6 to 30, preferably 1.7 to 20, preferably 1.8 to 10, preferably 1.8 to 5, preferably 1.8 to 3, preferably 1.8 to 2.5); and/or
10) Mooney viscosity, ML(1+4) @ 125° C., of 10 to 100 (preferably 15 to 10090, preferably 20 to 85).

Particularly preferred EP rubbers for use herein contain no diene (i.e., an ethylene-propylene copolymers). If diene is present (i.e., an ethylene-propylene-diene terpolymer), preferably the diene is a norbornene-derived diene such as ethylidene norbornene (ENB), vinylidene norbornene (VNB), or dicyclopentadiene (DCPD). Diene content is measured by ASTM D 6047.

The method of making the EP rubber is not critical, as it can be made by slurry, solution, gas-phase, high-pressure, or other suitable processes, through the use of catalyst systems appropriate for the polymerization of polyolefins, such as Ziegler-Natta catalysts, metallocene catalysts, other appropriate catalyst systems or combinations thereof.

In a particularly preferred embodiment, the EP rubbers useful herein are produced using a vanadium-based catalyst system in a solution or slurry process. In another embodiment, the EP rubbers useful herein are produced using a metallocene-based catalyst system in a solution or slurry process. In yet another embodiment, the EP rubbers useful herein are produced using any single-sited catalyst system in a solution or slurry process. Preferably, the EP rubbers made by a vanadium, metallocene, or other single-sited catalyst system has a molecular weight distribution (M_{w}/Mₙ) of 1.8 to 2.5.

EP rubbers that are useful in this invention include those available from ExxonMobil Chemical (sold under the Vistalon™ tradename), including:

ExxonMobil Chemical Vistalon ™ EP Rubbers

| | Mooney Viscosity | | | Molecular |
|---|---|---|---|---|
| | (ML1 + 4, | Ethylene | Diene | Weight |
| Grade | 125° C.) | (wt %) | (wt %) | Distribution |
| 404 | 28 | 45 | — | very broad |
| 504 | 25 | 60 | — | broad |
| 606 | 65 | 54 | — | broad |
| 703 | 21 | 73 | — | narrow |
| 706 | 42 | 65 | — | bimodal |
| 707 | 23 | 72 | — | very broad |
| 722 | 16 | 72 | — | narrow |
| 785 | 30 | 49 | — | narrow |
| 805 | 33 | 78 | — | narrow |
| 878 | 51 | 60 | — | narrow |
| MDV 91-9 | 18 | 59 | — | narrow |
| 1703P | 25 | 77 | 0.9 VNB | very broad |
| 2727 | 44 | 57 | 2.0 ENB | broad |
| 3708 | 52 | 70 | 3.4 ENB | broad |
| 2504 | 25 | 58 | 4.7 ENB | broad |
| 2727 | 44 | 56 | 2.0 ENB | broad |
| 4600 | 90 | 60 | 4.5 ENB | bimodal |
| 4709 | 78 | 75 | 4.4 ENB | narrow |
| 5504 | 25 | 45 | 4.7 ENB | medium |
| 5601 | 72 | 68 | 5.0 ENB | tailored |
| 6505 | 53 | 57 | 9.2 ENB | broad |
| 7000 | 59 | 73 | 5.0 ENB | narrow |
| 7001 | 60 | 73 | 5.0 ENB | tailored |
| 7500 | 82 | 56 | 5.7 ENB | bimodal |
| 7800(P) | 20 | 79 | 6.0 ENB | bimodal |
| 8600 | 81 | 58 | 8.9 ENB | bimodal |
| 8609 | 83 | 68 | 8.0 ENB | bimodal |
| 8800 | 15 | 73 | 10.0 ENB | bimodal |
| 9500 | 72 | 60 | 11.0 ENB | bimodal |

### Additives

Many additives may be incorporated in the present polymer composition in addition to the cyclic first copolymer component and the acyclic second copolymer component. Some additives aid in the processing of molded parts; others are added to improve the stability or aesthetics of molded parts. Useful additives include lactones, hydroxylamines, phosphates, clarifying agents, hindered amine anti-oxidants, aromatic amine anti-oxidants, hindered phenol anti-oxidants, divalent sulfur anti-oxidants, trivalent phosphorus anti-oxidants, metal deactivator anti-oxidants, heat stabilizers, low profile additives, UV stabilizers, lubricants, mold release agents, odorants, antistatic agents, antimicrobial agents, slip agents, anti-blocking agents, anti-foaming agents, blowing agents, anti-fogging agents, titanates, flame retardants, dyes, and colorants. Anti-oxidants and titanates are used in some of the compositions of this invention. Preferred anti-oxidant additives are Irganox 1010, Capow L-12/H, and Irgafos 168 combined with FS-042. Irganox 1010, Irgafos 168, and FS-042 are available from Ciba. Capow L-12/H is a titanate available from Kenrich.

Processing oils can be added in compounding to improve the moldability of the present composition. Plasticizers are added to polymers to lower their glass transition temperatures and to improve impact properties For example, processing oils could be added to the polyolefin modifiers to further lower their glass transition temperatures. Useful processing oils and plasticizers for the compositions of this invention include poly(1-decene), aliphatic petroleum distillates, aromatic petroleum distillates, alicyclic petroleum distillates, wood byproducts, natural oils, and synthetic oils.

In another embodiment, plasticizers such as those described as non-functional plasticizers (NFP's) in WO 04/014998 at pages 9 to 28, particularly pages 16 line, 14 to page 20, line 17) are added to the compositions of this invention.

Crosslinking agents can also be added to the present composition to vulcanize the second copolymer component, to create grafts between the cyclic olefin first copolymers and the second copolymer, to functionalize either the cyclic olefin copolymer or the second copolymer, and to cure the composition into a thermoset. Useful crosslinking agents include hydrogen peroxide, alkylhydroperoxides, diacylperoxides, dialkylperoxides, peracids, peresters, sulfur with and without accelerators, zinc with benzothiazole acceleration, phenolic resin curatives, silanes with Pt catalysts or free radical initiators, benzoquinone derivatives, bismaleimides, and metal oxides.

### Method of Making the Polymer Composition

The present composition can be prepared by any one of the following methods:

1. Melt blending of a preformed cyclic olefin copolymer (also referred to as the first copolymer), a preformed polyolefin modifier (also referred to as the second copolymer), and any other components in a mixer such as a Braebender Plasticorder or a Banbury mixer or in an extruder. A preferred method is a twin screw extruder with a high mixing intensity.

### 2. Mixing solutions or suspensions of the modifier and the cyclic olefin copolymer, possibly followed by extrusion or melt mixing to add other components.

### 3. Polymerization in a staged reactor, where the polyolefin modifier is made in the first reactor and the cyclic olefin copolymer is made in a second reactor, possibly followed by extrusion or melt mixing to add other components.

### 4. Polymerization in a staged reactor, where the cyclic olefin copolymer is made in a first reactor and a polyolefin modifier is made in a second reactor, possibly followed by extrusion or melt mixing to add other components.

### 5. Polymerization of the polyolefin modifier in a solvent containing dissolved cyclic olefin copolymer, possibly followed by extrusion or melt mixing to add other components.

### 6. Polymerization of the cyclic olefin copolymer in a solvent containing dissolved polyolefin modifier, possibly followed by extrusion or melt mixing to add other components.

7. Polymerization of both the polyolefin modifier and the cyclic olefin copolymer in the same reactor using two or more catalysts, possibly followed by extrusion or melt mixing to add other components. A chain shuttle agent may or may not be used to make block copolymers in this type of polymerization.
8. Polymerization where the second double bond of a diene in the polyolefin modifier or the cyclic olefin copolymer is partially incorporated into other chains of the same type by the polymerization catalyst, leading to long chain branched or gelled polyolefin modifiers or cyclic olefin copolymers.
9. Polymerization where the second double bonds of a diene in the polyolefin modifier or cyclic olefin copolymer is incorporated into chains of other types of polymers by the polymerization catalyst leading to graft copolymers between different polyolefin modifiers, different cyclic olefin copolymers, or between a polyolefin modifier and cyclic olefin copolymer.
10. Crosslinking where an agent is added during mixing to crosslink a second double bond of either the polyolefin modifiers or the cyclic olefin copolymers with other double bonds in the composition, typically leading to long chain branched or gelled polyolefin modifiers or cyclic olefin copolymer and/or grafts between polyolefin modifiers, between cyclic olefin copolymers, or between polyolefin modifiers and cyclic olefin copolymers.
11. Functionalization where the second double bonds of dienes in either cyclic olefin copolymers or polymer modifiers or both are functionalized after the cyclic olefin copolymers and polymer modifiers are already mixed together by one of the preparation methods 1 through 9.
12. Compositions containing functionalized polyolefin modifiers or cyclic olefin copolymers made by preparation methods 1, 2, or 11, which are crosslinked as described in preparation methods 8-10, except that reaction occurs between the functional groups instead of a second double bond.

### 13. Any combination of the techniques described in preparation methods 1-12.

### Polymer Composition

The present polymer composition has many outstanding properties, including a room temperature (23° C.) notched Izod impact resistance at 23° C. greater than 500 J/m, such as greater than 550 J/m for example greater than 600 J/m, even greater than 700 J/m. In these tests no breaks are observed. The composition also has no breaks in notched Izod impact tests at −18° C. and exhibits an impact resistance at this temperature of greater than 50 J/m. such as greater than 150 J/m, for example greater than 300 J/m, even greater than 500 J/m.

In instrumented impact tests the composition has only ductile failures at room temperature and at −29° C. and in particular exhibits instrumented impact energy measured at 23° C. of greater than 25 J, even greater than 30 J and an instrumented impact energy measured at −29° C. of greater than 25 J, even greater than 30 J. These impact properties are comparable to polycarbonates, ABS, poly(methylmethacrylate), and the best high impact polypropylene blends.

However, the heat distortion temperature of the present composition, using both 0.45 and 1.80 MPa loads, is much higher than can be achieved with toughened polypropylene blends. In particular, the present polymer composition exhibits a heat distortion temperature measured using a 0.46 MPa load of greater than 150° C., typically greater than 165° C. and a heat distortion temperature measured using a 1.80 MPa load of greater than 115° C., typically greater than 130° C., even greater than 145° C.

Moreover, the flexural modulus (1% secant method) of the composition is greater than 1200 MPa, such as greater than 1600 MPa, for example greater than 2000 MPa, even greater than 2500 MPa, which is significantly higher than that of current high impact polypropylene TPOs. (See FIG. 6 for a radar plot comparing a blend of the first embodiment of the invention with a state-of-the-art polypropylene TPO) These properties are much better than any others reported in the literature for blends of polyolefin modifiers and cyclic olefin copolymers.

### Production of Articles

Articles can be formed using the present composition by injection molding, compression molding, transfer molding, reaction injection molding, thermoforming, pressing, rotational molding, blow molding, extrusion, extrusion covering, co-extrusion with other polymers, pultrusion alone or with other polymeric materials, lamination with other polymers, coating, fiber spinning, film blowing, film casting, calendaring, or casting. Articles can also be made by any of these methods, where double bonds remaining in the polyolefin modifier or cyclic olefin copolymer or their functional groups are crosslinked after the articles are formed either thermally or with one of the crosslinking agents.

The present polymer composition opens up many new applications for cyclic olefin copolymers. Since the present composition overcomes or alleviates the problem with brittleness of cyclic olefin copolymers, it can be used in most of the applications where other engineering thermoplastics are used. The present teachings can be used to make toughened, reinforced, compositions with all types of cyclic olefins and represents a major step forward for these materials.

The polymer compositions described herein are specifically useful for the fabrication of parts of an automobile including:

1. Chassis, mechanics and under the hood applications including gas tanks; bumpers beams; bumper energy absorbers; bumper fascias; grille opening reinforcements; grille opening panels; front end fascia and grilles; front end modules; front end carriers; bolsters; valve covers; rocker arm covers; cylinder head covers; engine covers; engine splash shields; engine timing belt covers; engine air cleaners; engine oil pans; battery cases and trays; fluid reservoirs; cooling system components including cooling fans and shrouds and supports and radiator supports and end tanks; air intake system components; air ducting; wheel covers; hub caps; wheel rims; suspension and transmission components; and switches and sockets.
2. Interior applications including parts of instrument panels (IP) including IP carriers and retainers, IP basic structures, IP uppers, IP lowers, and IP instrument clusters; air bag housings; interior pedals; interior consoles including center and overhead consoles and console trim; steering column housings; seat structures including seat backs and pans; interior trim including pillar trim, IP trim, and door trim panels; liftgate and hatch inner panels; door and window handles; HVAC housing; load floors; trunk liners; storage systems; package trays; door cores and door core modules.
3. Body applications including underbody panels and streamlining; rocker panels; running boards; pickup boxes; vertical body panels including fenders, quarter panels, liftgate and hatch outer panels, and door outer panels; horizontal body panels including hoods, trunks, deck lids, and roofs and roof modules; spoilers; cowl vent leaf catchers, grilles, and screens; spare wheel wells; fender liners; exterior trim; exterior door handles; signal lamp housings; head and rear lamp housings; and mirror housings.

The polymer compositions described herein can also be used to fabricate parts similar to those listed for automobiles but for heavy trucks and mass transit vehicles, such as buses, trains, and airplanes, as well as for recreational vehicles such as snowmobiles, all-terrain vehicles, sailboats, powerboats, and jet skis. Other uses for the polymer compositions described herein include the fabrication of (a) recreational goods such as toys, helmets, bicycle wheels, pool equipment housings, and rackets; (b) parts for large consumer appliances, such as washing machine tubs, refrigerator interior liners, and appliance exterior housings; (c) housings for business machines, hand tools, laboratory instruments, electronic equipment, small machinery and appliances; (d) parts for furniture; (e) structural elements in residential and commercial building and construction such as exterior panels and curtain walls, window and door frames, fascia and soffits, shutters, and HVAC components; and (f) fabricate large waste management containers.

This invention further relates to:

1. A polymer composition comprising:
(a) greater than 50 wt % (based upon the weight of the composition) of a cyclic olefin copolymer, said cyclic olefin copolymer comprising at least one acyclic olefin and at least 20 weight % of one or more cyclic olefins (based upon the weight of the cyclic olefin copolymer), wherein at least a portion of said cyclic olefin copolymer has a glass transition temperature of greater than 150° C.;
(b) less than 50 wt % (based upon the weight of the composition) of an acyclic olefin polymer modifier, at least a portion of the modifier having a glass transition temperature of less than −30° C.; and no portion of the modifier having a softening point greater than +30° C., the Bicerano solubility parameter of the modifier being no more than 0.6 J^{0.5}/cm^{1.5} less than the Bicerano solubility parameter of the cyclic olefin copolymer;
wherein the notched Izod impact resistance of the composition measured at 23° C. is greater than 500 J/m and the heat distortion temperature of the composition measured using a 0.46 MPa load is greater than 135° C.
2. The polymer composition of paragraph 1 wherein said cyclic olefin copolymer comprises at least 30 weight %, preferably at least 40 weight %, of one or more cyclic olefins.
3. The polymer composition of paragraph 1 or paragraph 2 wherein at least a portion of said cyclic olefin copolymer has a glass transition temperature greater than 160° C., preferably greater than 170° C.
4. The polymer composition of any one of paragraphs 1 to 3 wherein a portion of said cyclic olefin copolymer has a softening temperature of less than 30° C.
5. The polymer composition of any one of paragraphs 1 to 4 wherein all of said cyclic olefin copolymer has a glass transition temperature greater than 150° C.
6. The polymer composition of any one of paragraphs 1 to 5 wherein a portion of said polymer modifier has a glass transition temperature of less than −40° C., preferably less than −50° C.
7. The polymer composition of any one of paragraphs 1 to 6 wherein all of the said polymer modifier has a glass transition temperature of less than −30° C.
8. The polymer composition of any one of paragraphs 1 to 7 wherein no portion of said polymer modifier has a softening point greater than 10° C.
9. The polymer composition of any one of paragraphs 1 to 8 wherein said polymer modifier has an Bicerano solubility parameter 0.1-0.5 J^{0.5}/cm^{1.5}, preferably 0.2-0.4 J^{0.5}/cm^{1.5}, less than the Bicerano solubility parameter of the cyclic olefin copolymer.
10. The polymer composition of any one of paragraphs 1 to 9 and comprising about 20 wt % to about 40 wt %, preferably 25 wt % to 35 wt %, of said polymer modifier.
11. The polymer composition of any one of paragraphs 1 to 10 wherein the notched Izod impact resistance of the composition measured at 23° C. is greater than 550 J/m, preferably greater than 600 J/m, more preferably greater than 700 J/m.
12. The polymer composition of any one of paragraphs 1 to 11 wherein the heat distortion temperature of the composition measured using a 0.46 MPa load is greater than 150° C., preferably greater than 165° C.
13. The polymer composition of any one of paragraphs 1 to 12 wherein the heat distortion temperature of the composition measured using a 1.80 MPa load is greater than 115° C., preferably greater than 130° C., more preferably greater than 145° C.
14. The polymer composition of any one of paragraphs 1 to 13 wherein notched Izod impact resistance of the composition measured at −18° C. is greater than 50 J/m, preferably greater than 150 J/m, more preferably greater than 300 J/m, most preferably greater than 500 J/m.
15. The polymer composition of any one of paragraphs 1 to 14 wherein the instrumented impact energy of the composition measured at 23° C. is greater than 25 J, preferably greater than 30 J.
16. The polymer composition of any one of paragraphs 1 to 15 wherein the instrumented impact energy of the composition measured at −29° C. is greater than 25 J, preferably greater than 30 J.
17. The polymer composition of any one of paragraphs 1 to 16 wherein the flexural modulus of the composition measured using the 1% secant method is greater than 1200 MPa, preferably greater than 2000 MPa, more preferably greater than 2500 MPa.
18. The polymer composition of any one of paragraphs 1 to 17 wherein said polymer modifier comprises a copolymer of ethylene, a higher alpha-olefin, and at least 5 wt % but less than 20 wt % of a cyclic olefin.
19. The polymer composition of paragraph 18 wherein the cyclic olefin is selected from norbornene, ethylidene norbornene, vinylnorbornene, vinylcyclohexene and dicyclopentadiene.
20. The polymer composition of paragraph 18 or paragraph 19 wherein the alpha olefin is selected from propylene, hexene and octene.
21. The polymer composition of any one of paragraphs 1 to 17 wherein said polymer modifier comprises a polymer comprising ethylene, propylene, and optionally one or more dienes.
22. The polymer composition of paragraph 21 wherein the polymer comprises from 25 to 80 wt % of ethylene, up to 15 wt % of one or more dienes and the balance propylene.
23. The polymer composition of any one of paragraphs 1 to 17 wherein said polymer modifier comprises a copolymer of ethylene and 7-methyl-1,6-octadiene.
24. The polymer composition of any one of paragraphs 1 to 23 wherein said cyclic olefin copolymer comprises a copolymer of ethylene with norbornene and/or dicyclopentadiene.
25. The polymer composition of any one of paragraphs 1 to 24 wherein some or all of the remaining double bonds of the cyclic olefin copolymer are hydrogenated, epoxidized and/or functionalized.
26. The polymer composition of any one of paragraphs 1 to 25 and comprising a melt blend of said cyclic olefin copolymer (a) and said polymer modifier (b).
27. A component for an automobile fabricated from the polymer composition of any one of paragraphs 1 to 26.

In the foregoing description, the Examples and the claims, the following test methods are employed to measure the various parameters identified.

Heat distortion temperatures (HDT) were measured using ASTM methods D648-06 and D1525-00. Before testing, the samples were conditioned for at least 40 hours @ 23° C.±2° C. and 50%±5% humidity. ASTM test bars were 0.125″ thick×5″ wide×5″ length.

Density or specific gravity was measured using ASTM D972-00 Method A. Specimens were cut with a clipper belt cutter from the center portion of standard flexular modulus test samples. The length of the samples were approximately 3½ inches. Before testing, the samples were conditioned at 23±2° C. and 50±5% relative humidity for a minimum of 40 hours.

Maximum tensile stress, tensile Young's modulus, and tensile energy at break were measured using ASTM method D638-03. At least five specimens per sample were tested. Before testing, the samples were conditioned for 40 hours at 23° C.±2° C. and 50%±5% relative humidity in bags.

Flexural Young's modulus, flexural modulus at 1% tangent, and flexural modulus at 1% secant were collected according to ASTM method D790-03. At least five specimens per sample were tested. Before testing, the samples were conditioned for 40 hours at 23° C.±2° C. and 50%±5% relative humidity in bags.

Room temperature (23° C.) and low temperature (−18° C.) notched Izod were measured according to ASTM method D256-06. The test specimens were 2.5 inches long, 0.5 inches wide, and 0.125 inches thick. At least five specimens were cut using a clipper belt cutter from the uniform center of Type I tensile bars. Samples were notched using a TMI Notching cutter. Samples were conditioned at 23±2° C. and 50±5% relative humidity for a minimum of 40 hours after cutting and notching. For sub-ambient testing, notched test specimens were conditioned at the specified test temperature for a minimum of one hour before testing. The types of break observed in the notched Izod impact tests are coded as follows:
C means complete break,
NB means no break,
P is a partial break where the top stays above the line of the break, and
H is a hinged partial break where the top portion hangs below the line of the break.

Instrumented impact at room temperature, −18° C., and −29° C. were measured according to ASTM method D3763-02. Standard test specimens are 4.0 in. diameter disks. A minimum of five specimens were tested for each sample at each temperature. Before testing, samples were conditioned at 23±2° C. and 50±5% relative humidity for a minimum of 40 hours. If high or low temperature testing was performed, the specimens to be tested were conditioned for 4 hours prior to testing. The types of breaks observed in the instrumented impact tests are coded as follows:
B means a brittle failure,
BD means a brittle failure showing some ductile flow,
DB is a ductile failure where the polymer has deformed out of the way of the projectile but has cracked,
D is a failure where the polymer deformed out of the way of the projectile without any cracking.

The 60 degree gloss measurements used ASTM method 523-89. Samples were free of dust, scratches or finger marks.

Rockwell hardness was measured using ASTM 785-03 procedure A and ASTM 618-05. Samples were conditioned at 23±2° C. and 50±5% relative humidity for a minimum of 40 hours. The standard test specimens were at least 6 mm (¼ in.) thick.

Melt flow rates at 230 C and 300 C were measured according to ASTM method D1238-04c.

Shore A and D hardness were collected using ASTM method D2240-05. The test specimens were at least 6 mm (0.25 inches) thick.

All molecular weights are number average unless otherwise noted.

Bicerano solubility parameters were determined by the Van Krevelen method described in chapter 5 of Jozef Bicerano's Prediction of Polymer Properties, 3^{rd} Edition, Marcel Dekker, Inc., 2002. A programmed version of this estimation method was used in the example tables. It is available in the Polymer Module of the molecular modeling software package, Cerius², version 4.0, available from Accelrys, Inc.

### EXAMPLES

The invention will now be more particularly described with reference to the following non-limiting Examples.

The following materials were used in Examples:

| Material | Source | Properties |
|---|---|---|
| Vistalon 8600 | ExxonMobil | Bimodal EPDM rubber containing 57 wt % |
| | Chemical Company | ethylene, 8.9 wt. % ethylidene norbornene, 34.1 |
| | | wt. % propylene. Tg is −45.15° C. and rubber has |
| | | no other feature (no softening point) in its DSC |
| | | trace run at 10° C./min. |
| Vistalon 9500 | ExxonMobil | Bimodal EPDM rubber containing 60 wt. % |
| | Chemical Company | ethylene, 11 wt. % ethylidene norbornene, 29 |
| | | wt. % propylene. Tg is −41.64° C. and rubber has |
| | | no other feature (no softening point) in its DSC |
| | | trace run at 10° C./min. |
| Vistalon 7001 | ExxonMobil | Metallocene based bimodal EPDM containing |
| | Chemical Company | 73 wt. % ethylene, 5 wt. % ethylidene |
| | | norbornene, 22 wt. % propylene. Tg is −39.13° C. |
| | | and rubber has a melting peak at 45° C. in its |
| | | DSC trace. |
| Exxelor PO 1020 | ExxonMobil | Homopolymer of PP grafted with 0.5-1.0 wt. % |
| | Chemical Company | maleic anhydride. MPt of 160° C. |
| Exxelor VA 1803 | ExxonMobil | Amorphous ethylene copolymer grafted with |
| | Chemical Company | 0.5-1.0 wt. % maleic anhydride. Glass transition |
| | | temperature of −57° C. |
| MDV91-9 | ExxonMobil | Ethylene-propylene copolymer containing 59.3 |
| | Chemical Company | wt. % ethylene |
| Exact 5061 | ExxonMobil | Metallocene based ethylene-octene copolymer |
| | Chemical Company | with melting point of 52.8° C. |
| PP8231E1 | ExxonMobil | High impact propylene copolymer with HDT at |
| | Chemical Company | 0.46 MPa of 92° C. |
| Vector 8508 | Dexco Polymer LP | Linear styrene-butadiene-styrene block |
| | | copolymer containing 29 wt. % styrene |
| Kraton G1650 | Kraton | Linear styrene-ethylene/butylene-styrene block |
| | | copolymer containing 30 wt. % styrene, |
| | | Brookfield viscosity 8000 cps |
| Kraton G1651 | Kraton | Linear styrene-ethylene/butylene-styrene block |
| | | copolymer containing 33 wt. % styrene, |
| | | Brookfield viscosity >50,000 cps |
| Kraton G1652 | Kraton | Linear styrene-ethylene/butylene-styrene block |
| | | copolymer containing 30 wt. % styrene, |
| | | Brookfield viscosity 1800 cps |
| Septon 2004 | Kuraray | Styrene-ethylene/propylene-styrene block |
| | | copolymer containing 18 wt. % styrene, solution |
| | | viscosity 145 cps |
| Septon 2007 | Kuraray | Styrene-ethylene/propylene-styrene block |
| | | copolymer containing 30 wt. % styrene, solution |
| | | viscosity 70 cps |
| Septon HG-252 | Kuraray | Styrene-ethylene-ethylene/propylene-styrene |
| | | block copolymer containing 28 wt. % styrene, |
| | | solution viscosity 70 cps |
| Topas 6015 | Topas Advanced | Metallocene-based Ethylene/Norbornene |
| | Polymers | copolymer with HDT at 0.46 MPa of 150° C. and |
| | | Tg of 160° C. |
| Topas 6017 | Topas Advanced | Metallocene-based Ethylene/Norbornene |
| | Polymers | copolymer with HDT at 0.46 MPa of 170° C. and |
| | | Tg of 180° C. |

### Test Sample Preparation and Measurement Methods

The compression molded samples were melt mixed at 230° C. in a Braebender Plasticorder in 40 gram batches. Test samples were compression molded at 215° C. using a Wabash press.

The injection molded blends were melt mixed at 230° C. in a Warner-Pflider WP-30 mm twin screw extruder. A total of ten pounds of ingredients were added through the throat of the extruder. The first two pounds were discarded. Test samples were fabricated at 250° C. using a 110 ton Van Dorn injection molding machine. The first 15 shots were discarded.

### Examples 1 and 2 and Comparative Examples 1 to 8

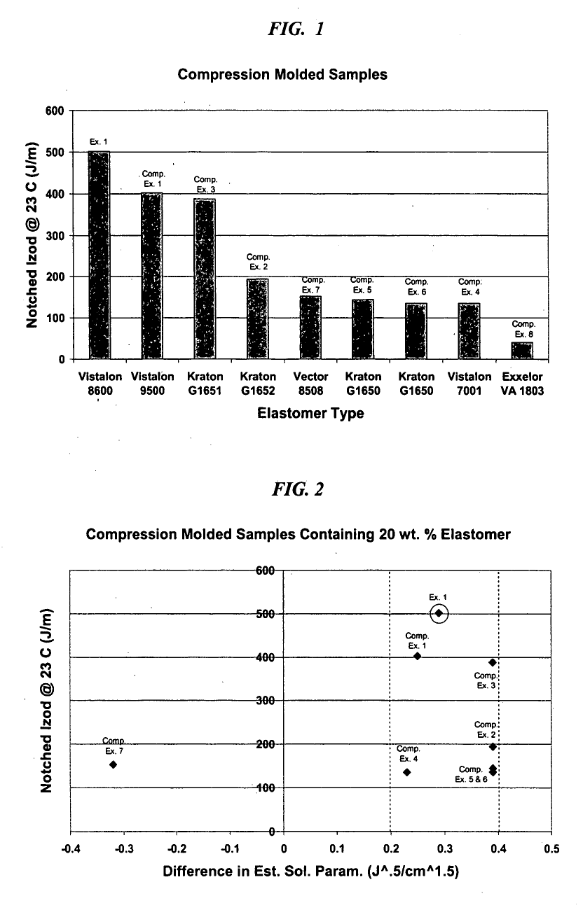

Compression molded flexural bars were prepared from mixtures of 80 wt % of TOPAS 6015 with 20 wt % of each of the elastomers listed in Table 1. The bars were used for flexural tests and were cut for use in notched Izod impact tests at room temperature and −18° C. and heat distortion tests at 1.80 MPa. The results of the tests are presented in FIG. 1 and Tables 1 and 2.

TABLE 1
Compression Molded Screen For Best Rubbers

| | | | Comp. | Comp. | Comp. |
|---|---|---|---|---|---|
| | Ex. 1 | Ex. 2 | Ex. 1 | Ex. 2 | Ex. 3 |
| Topas 6015 (pph) | 80 | 80 | 80 | 80 | 80 |
| Vistalon 8600 (pph) | 20 | 20 | | | |
| Kraton G1651 (pph) | | | | | 20 |
| Kraton G1652 (pph) | | | | 20 | |
| Vistalon 9500 (pph) | | | 20 | | |
| Flex Young's Modulus | 2010 | | | | |
| (MPa) | | | | | |
| Flex Mod (1% tan) | 1937 | 1924 | | | |
| (MPa) | | | | | |
| Flex Mod (1% sec) | 1986 | 1882 | | | |
| (MPa) | | | | | |
| HDT at 1.80 MPa (C.) | | 124.8 | | | |
| RTNI (J/m) | 501.8 | | 402.5 | 193.8 | 388.1 |
| Type of Breaks | 7NB | | 4NB; | 6P; 5C | 7NB |
| | | | 1P | | |
| | | | 1H; 1C | | |
| NI @ −18 C. (J/m) | 271.2 | | | | |
| Type of Breaks | 5P | | | | |
| Bicerano Solubility | .29 | .29 | 0.25 | .39, | .39 |
| Parameter | | | | −2.62 | −2.62 |
| Difference J^{.5}/cm^{1.5} | | | | | |

TABLE 2
Compression Molded Screen For Best Rubbers

| | Comp. | Comp. | Comp. | Comp. | Comp. |
|---|---|---|---|---|---|
| | Ex. 4 | Ex. 5 | Ex. 6 | Ex. 7 | Ex. 8 |
| Topas 6015 (pph) | 80 | 80 | 80 | 80 | 80 |
| Vistalon 7001 (pph) | 20 | | | | |
| Kraton G1650 (pph) | | 20 | 20 | | |
| Vector 8508 (pph) | | | | 20 | |
| Exxelor VA 1803 (pph) | | | | | 20 |
| Flex Young's Modulus (MPa) | | | 2030 | | |
| Flex Mod (1% tan) (MPa) | | | 1896 | | |
| Flex Mod (1% sec) (MPa) | | | 2006 | | |
| RTNI (J/m) | 135.6 | 144.7 | 136.1 | 153.2 | 41.4 |
| Types of Breaks | 4NB; 4P | 3NB; 1H | 1NB; 1P | 3NB; 3P | 12C |
| | 2C | 8C | 10C | 2H; 4C | |
| NI @ −18 C. (J/m) | | | 42.0 | | |
| Types of Breaks | | | 5C | | |
| Bicerano Solubility Parameter | .23 | .39 | .39 | −.32 | |
| Difference J^{.5}/cm^{1.5} | | −2.62 | −2.62 | −2.62 | |

The data show that the best toughening (highest notched Izod impact) occurs with Vistalon 8600, which is a non-crystalline ethylene-propylene-ethylidene norbornene random terpolymer containing 8.9 wt. % ethylidene-norbornene. Of the elastomers tested, only the Vistalon 8600 compression molded sample had more than 500 J/m impact resistance. Apparently, the high glass transition temperature ethylene/norbornene copolymers, such as Topas 6015, need a slightly polar elastomer for good impact properties. The slight polarity of Vistalon 8600 comes from its high diene content.

To assess the effect of elastomer polarities in blends with Topas 6015 or Topas 6017, Bicerano solubility parameters have been determined for most of the polymers tested in the above Examples. The Bicerano solubility parameters for Topas 6015 and Topas 6017 were determined using 53 and 58 mole % norbornene content, respectively. Both Topas polymers have an Bicerano solubility parameter value of 16.88 J^{0.5}/cm^{1.5}. The Bicerano solubility parameter differences in Tables 1 and 2 are calculated by subtracting the Bicerano solubility parameter for the elastomers from this value.

Room temperature notched Izod impact resistance's are plotted against differences in Bicerano solubility parameters (noted as Est. Sol. Param.) in FIG. 2 for seven of the elastomers tested. The best performance is obtained when the differences in Bicerano solubility parameters between the Topas 6015 and elastomers is between 0.2 and 0.4 J^{0.5}/cm^{1.5}. These limits are shown as dashed vertical lines in FIG. 4.

The results summarized in Tables 1 and 2 and FIGS. 1 and 2 suggest that the EPDM elastomers (Vistalon 8600 and 9500) are more effective than the styrenic block copolymers (Kraton G1650, G1651, G1652, and Vector 8508) in impact modification of the cyclic copolymer. The Bicerano solubility parameter differences indicate that the polystyrene blocks (second differences in Comparative Examples 2, 3, 5, 6, and 7) are too polar to be compatible with the Topas polymers. Any impact modification is coming from the ethylene/butylene and butadiene blocks of these SEBS and SBS triblock copolymers. The styrenic blocks of these copolymers have glass transition temperatures of at least 70° C.

The heat distortion temperature (HDT) at 1.80 MPa of the sample obtained in Example 2 is significantly higher than can be achieved with Topas 6013, because Topas 6015 has a 20° C. higher glass transition temperature than Topas 6013. This HDT is also much higher than can be achieved with blends of polypropylenes.

The blend with the maleic anhydride grafted amorphous ethylene copolymer in Comparative Example 8 gave very poor impact toughness. Apparently, only a narrow range of elastomer polarities matches the polarity of the Topas cyclic olefin copolymers and leads to a high notched Izod impact resistance. The Bicerano solubility parameter difference for the elastomer in Comparative Example 8 could not be calculated due to a lack of exact compositional information.

### Example 3 and Comparative Example 9

Compression molded flexural bars were prepared from mixtures of 70 wt % of TOPAS 6017 with 30 wt % of each of the elastomers listed in Table 3. The bars were tested as in Example 1 and the results are summarized in Table 3. It will be seen that Topas 6017 is also impact toughened with Vistalon 8600, although the impact modification of this very high glass transition temperature (180° C.) material seems to be more difficult. This blend also has more than 500 J/m impact resistance. A slight change in the elastomer (Vistalon 7001) leads to a poorer result, although Topas 6015 and 6017 have the same Bicerano solubility parameter differences. Example 3 and Comparative Example 9 show that addition of higher levels of elastomers decreases the flexural modulus of the blends.

TABLE 3
Compression Molded - 30 wt. % Elastomer

| | | Comp. |
|---|---|---|
| | Ex. 3 | Ex. 9 |
| Topas 6017 (pph) | 70 | 70 |
| Vistalon 8600 (pph) | 30 | |
| Vistalon 7001 (pph) | | 30 |
| Flex Young's Modulus (MPa) | 1228 | 1193 |
| Flex Mod (1% tan) (MPa) | 1193 | 1175 |
| Flex Mod (1% sec) (MPa) | 1216 | 1175 |
| RTNI (J/m) | 512.4 | 281.6 |
| Types of Breaks | 5NB | 2NB, 2P, 1H |
| Bicerano Solubility | .29 | .23 |
| Parameter Difference | | |
| J^{.5}/cm^{1.5} | | |

### Examples 4 and 5 and Comparative Examples 10 to 30

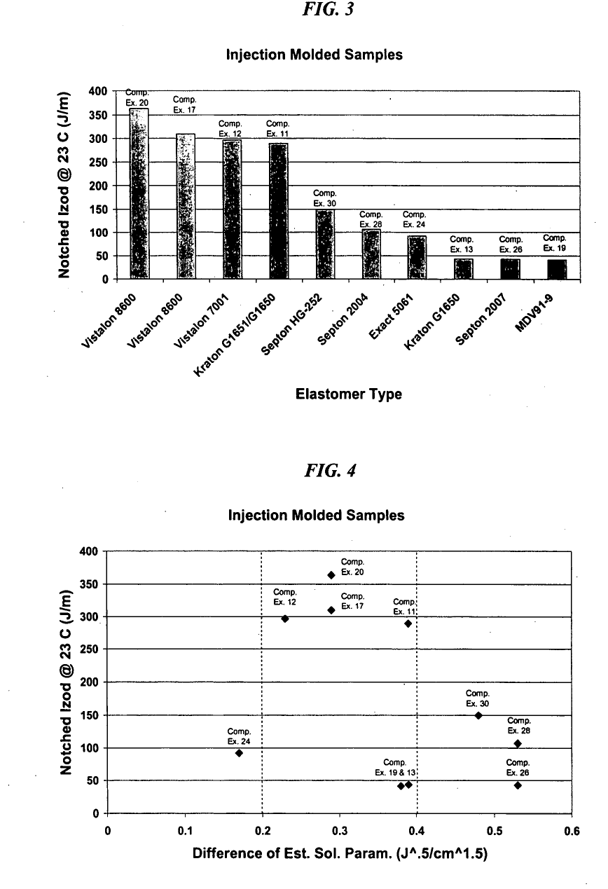

In these Examples blends of Topas 6015 and Topas 6017 were prepared with varying amounts of elastomer using a twin screw extruder to melt mix the blends. Test specimens were prepared using injection molding. The results are summarized in Tables 4 to 8 and FIG. 3.

TABLE 4
Injection Molded - Screen By Elastomer Type

| | Comp. | Comp. | Comp. | Comp. |
|---|---|---|---|---|
| | Ex. 10 | Ex. 11 | Ex. 12 | Ex. 13 |
| Topas 6015 (pph) | 100 | 80 | 80 | 80 |
| Vistalon 7001 (pph) | | | 20 | |
| Kraton G1650 (pph) | | 10 | | 20 |
| Kraton G1651 (pph) | | 10 | | |
| Density (g/ml) | 1.028 | 1.007 | 0.993 | 1.002 |
| Flex Young's Mod. | 3200 | 2300 | 2200 | 2400 |
| (MPa) | | | | |
| Flex Mod (1% tan) | 3089 | 2213 | 2234 | 2386 |
| (MPa) | | | | |
| Flex Mod (1% sec) | 3151 | 2282 | 2179 | 2386 |
| (MPa) | | | | |
| HDT at 0.46 MPs (C.) | 144.9 | 142 | 141 | 142.5 |
| HDT at 1.80 MPa (C.) | 128.5 | 122.8 | 120.1 | 123.2 |
| RTNI (J/m) | 22.5 | 289.2 | 296.6 | 43.3 |
| Type of Breaks | 5C | 5P | 5P | 5C |
| NI @ -18 C. (J/m) | 18.9 | 115.9 | 82.5 | 19.5 |
| Type of Breaks | 5C | 5C | 5C | 5C |
| CLTE (10⁻⁵/C.) | 5.97 | 7.32 | 9.97 | |
| By DMTA | | | | |
| 60 deg. Gloss | | 72.3 | 79.3 | 90.2 |
| Inst. Impact @ RT (J) | | 42.82 | 39.90 | 41.04 |
| 5 mph, 117# | | | | |
| Type of Breaks | | 5D | 5D | 5D |
| Inst. Impact @ -29 C. | | 19.62 | 48.12 | 7.05 |
| (J) 5 mph 117# | | | | |
| Type of Breaks | | 3BD | 5D | 4BD |
| | | 2DB | | 1B |
| Max Tensile Stress | 61.4 | 46.2 | 46.2 | 55.2 |
| (MPa) | | | | |
| Tensile Young's Mod. | 3300 | 2500 | 2350 | 2700 |
| (MPa) | | | | |
| Tensile Energy@Break | 1.76 | 3.39 | 5.56 | 3.80 |
| (J) | | | | |
| Tensile Strain@Break | 2.7 | 5.1 | 7.8 | 5 |
| (%) | | | | |
| Tensile Yield Strain (%) | | 3.4 | 3.6 | 3.8 |
| Rockwell Hardness | 125.3 | 109.5 | 99.4 | 105.1 |
| Melt Flow @ 230 C. | 0.35 | 0.179 | 0.255 | 0.25 |
| Melt Flow @ 300 C. | 18.42 | 7.88 | 9.35 | 11.1 |
| Shore A Hardness | 75 | 70 | 69 | 69 |
| Shore D Hardness | 74 | 70 | 67 | 68 |
| Bicerano Solubility | | .39 | .23 | .39 |
| Parameter Difference | | −2.62 | | −2.62 |
| J^{.5}/cm^{1.5} | | | | |

TABLE 5
Injection Molded - Screen on Amount of Rubber

| | Comp. | Comp. | Comp. | Comp. |
|---|---|---|---|---|
| | Ex. 14 | Ex. 15 | Ex. 16 | Ex. 17 |
| Topas 6015 (pph) | 95 | 90 | 85 | 80 |
| Vistalon 8600 (pph) | 5 | 10 | 15 | 20 |
| Density (g/ml) | 1.02 | 1.01 | 1.01 | 0.99 |
| Flex Young's Mod. (MPa) | 2900 | 2700 | 2400 | 2150 |
| Flex Mod (1% tan) (MPa) | 2944 | 2661 | 2330 | 2282 |
| Flex Mod (1% sec) (MPa) | 2868 | 2661 | 2434 | 2137 |
| HDT at 0.46 MPs (C.) | 144.1 | 142.9 | 142.8 | 140.5 |
| HDT at 1.80 MPa (C.) | 128.6 | 125.5 | 124.3 | 120.5 |
| RTNI (J/m) | 22.7 | 30.3 | 127.3 | 309.8 |
| Type of Breaks | 5C | 5C | 5P | 5NB |
| NI @ -18 C. (J/m) | 20.9 | 29.5 | 71.0 | 152.3 |
| Type of Breaks | 5C | 5C | 5C | 5P |
| CLTE (10⁻⁵/C.) By DMTA | | | | 7.58 |
| 60 deg. Gloss | 76 | 86.2 | 81.9 | 81.8 |
| Inst. Impact @ RT (J) | 4.51 | 29.68 | 39.96 | 39.96 |
| 5 mph, 117# | | | | |
| Type of Breaks | 5B | 5BD | 5D | 5D |
| Inst. Impact @ -29 C. (J) | | | 37.49 | 40.31 |
| 5 mph 117# | | | | |
| Type of Breaks | | | 2D,2BD | 5D |
| | | | 1DB | |
| Max Tensile Stress (MPa) | 61.4 | 55.8 | 50.3 | 44.8 |
| Tensile Young's Mod. (MPa) | 2900 | 2700 | 2500 | 2300 |
| Tensile Energy@Break (J) | 2.85 | 2.98 | 7.05 | 5.02 |
| Tensile Strain@Break (%) | 3.7 | 4 | 9 | 7.4 |
| Tensile Yield Strain (%) | | | 3.4 | 3.3 |
| Rockwell Hardness | 120.5 | 114.8 | 108.4 | 98.8 |
| Melt Flow @ 230 C. | 0.31 | 0.3 | 0.27 | 0.21 |
| Melt Flow @ 300 C. | 17.74 | 15.22 | 12.84 | 7.26 |
| Shore A Hardness | 75 | 74 | 72 | 68 |
| Shore D Hardness | 74 | 73 | 72 | 66 |
| Bicerano Solubility | .29 | .29 | .29 | .29 |
| Parameter Difference | | | | |
| J^{.5}/cm^{1.5} | | | | |

TABLE 6
Injection Molded-Comparison of High T_{g} Ethylene/Norbornenes

| | Comp. | Comp. | Comp. | Comp. | Comp. |
|---|---|---|---|---|---|
| | Ex. 18 | Ex. 19 | Ex. 20 | Ex. 21 | Ex. 22 |
| Topas 6015 (pph) | 89.9 | 79.9 | 79.9 | | |
| Topas 6017 (pph) | | | | 89.9 | 79.9 |
| Vistalon 8600 (pph) | 10 | | 20 | 10.0 | 20.0 |
| MDV91-9 (pph) | | 20 | | | |
| Irgafos168 | 0.1 | 0.1 | 0.1 | 0.1 | 0.1 |
| Density (g/ml) | 1.007 | 0.99 | 1.112 | 1.01 | 0.993 |
| Flex Young's Mod. (MPa) | 2500 | 2350 | 2600 | 2600 | 2200 |
| Flex Mod (1% tan) (MPa) | 2455 | 2261 | 2420 | 2475 | 2096 |
| Flex Mod (1% sec) (MPa) | 2482 | 2330 | 2344 | 2620 | 2151 |
| HDT at 0.46 MPa (C.) | 144.7 | 143.3 | 142.9 | 160 | 159 |
| HDT at 1.80 MPa (C.) | 126.8 | 125.1 | 121.3 | 142 | 138 |
| RTNI (J/m) | 90.7 | 41.3 | 363.5 | 81.1 | 191.1 |
| Type of Breaks | 5C | 5C | 5NB | 5C | 5P |
| NI @ −18 C. (J/m) | 43.8 | 21.2 | 137.2 | 43.4 | 126.0 |
| Types of Breaks | 5C | 5C | 5C | 5C | 5H |
| CLTE (10⁻⁵/C.) Flow | | | 5.3 | | |
| (−30 to 100 C.) | | | | | |
| CLTE (10⁻⁵/C.) X-Flow | | | 7 | | |
| (−30 to 100 C.) | | | | | |
| 60 deg. Gloss | 82.4 | 93.4 | 57.9 | 76.5 | 42.8 |
| Inst. Impact @ RT (J) | 34.98 | 39.41 | 34.26 | 21.76 | 34.93 |
| 15 mph, 25# | | | | | |
| Types of Breaks | 4DB; 1D | 5D | 5D | 5B | 3DB; 2D |
| Inst. Impact @ −29 C. (J) | | 19.89 | 21.67 | | |
| 15 mph 25# | | | | | |
| Types of Breaks | | 3BD; 2B | 5DB, 1B | | |
| Max Tensile Stress (MPa) | 51.41 | 48.42 | 36.22 | 52.97 | 42.66 |
| Tensile Young's Modulus | 2662 | 2600 | 3147 | 2711 | 2394 |
| (MPa) | | | | | |
| Tensile Energy@Break (J) | 4.20 | 4.75 | 6.37 | 4.47 | 7.19 |
| Tensile Strain@Break (%) | 5.5 | 6.2 | 10.4 | 5.6 | 10 |
| Tensile Yield Strain (%) | 3.2 | 3.4 | 2.9 | 3.4 | 3.5 |
| Rockwell Hardness | 114.5 | 92.7 | 86.8 | 116.3 | 104.6 |
| Melt Flow @ 300 C. | 13.1 | 14.6 | 4.05 | 9.2 | 6.4 |
| Shore A Hardness | 78 | 78 | 78 | 84 | 81 |
| Shore D Hardness | 81 | 74 | 74 | 82 | 77 |
| Bicerano Solubility Parameter | .29 | .38 | .29 | .29 | .29 |
| Difference J^{.5}/cm^{1.5} | | | | | |

TABLE 7
Injection Molded - Comparison of Variations in Composition

| | | | Comp. | Comp. |
|---|---|---|---|---|
| | Ex. 4 | Ex. 5 | Ex. 23 | Ex. 24 |
| Topas 6015 (pph) | 70 | | 69.8 | 79.8 |
| Topas 6017 (pph) | | 70 | | |
| Vistalon 8600 (pph) | 30 | 30 | | |
| Exact 5061 (pph) | | | | 20 |
| PP8231E1 (pph) | | | 30 | |
| Irgafos168 | | | 0.1 | 0.1 |
| FS-042 | | | 0.1 | 0.1 |
| Density (g/ml) | 0.977 | 0.978 | 0.983 | 0.999 |
| Flex Young's Mod. | 1662 | 1662 | 2200 | 2200 |
| (MPa) | | | | |
| Flex Mod (1% tan) | 1613 | 1606 | 2124 | 2172 |
| (MPa) | | | | |
| Flex Mod (1% sec) | 1662 | 1662 | 2124 | 2179 |
| (MPa) | | | | |
| HDT at 0.46 MPa (C.) | 139.2 | 154 | 138.4 | 143.3 |
| HDT at 1.80 MPa (C.) | 117.5 | 131 | 113 | 125.1 |
| RTNI (J/m) | 656.5 | 523.1 | 32.9 | 92.9 |
| Types of Breaks | 5NB | 5NB | 5C | 5H |
| NI @ -18 C. (J/m) | 458.5 | 400.3 | 25.3 | 29.7 |
| Types of Breaks | 5NB | 5NB | 5C | 5C |
| NI @ -29 C. (J/m) | 395.0 | 368.3 | | |
| Types of Breaks | 5P | 5P | | |
| 60 deg. Gloss | 35 | 39 | 93.3 | 93.5 |
| Inst. Impact @ RT (J) | | | 3.35 | 32.96 |
| 5 mph, 117# | | | | |
| Types of Breaks | | | 5B | 4D; 1DB |
| Inst. Impact @ -29 C. | 38.46 | 35.51 | | 9.25 |
| (J) 5 mph 117# | | | | |
| Types of Breaks | 5D | 5D | | 4BD; 1B |
| Inst. Impact @ RT (J) | 37.28 | 33.76 | | |
| 15 mph, 25# | | | | |
| Types of Breaks | 5D | 5D | | |
| Inst. Impact @ -29 C. (J) | 43.93 | 42.17 | | |
| 15 mph 25# | | | | |
| Types of Breaks | 5D | 5D | | |
| Max Tensile Stress | 33.12 | 33.10 | 38.61 | 51.71 |
| (MPa) | | | | |
| Tensile Young's | 1838 | 1737 | 2550 | 2540 |
| Modulus (MPa) | | | | |
| Tensile Energy@Break | 14.91 | 11.25 | 2.30 | 8.68 |
| (J) | | | | |
| Tensile Strain@Break | 25.6 | 19.1 | 4.2 | 10.9 |
| (%) | | | | |
| Tensile Yield Strain (%) | 3.7 | 3.5 | 3.2 | 3.8 |
| Rockwell Hardness | 81 | 80 | 94.5 | 101.8 |
| Melt Flow @ 300 C. | 4.1 | 3.3 | | |
| Shore A Hardness | 70 | 69 | 68 | 67 |
| Shore D Hardness | 66 | 65 | 64 | 66 |
| Bicerano Solubility | .29 | .29 | .82 | .17 |
| Parameter Difference | | | .28 | |
| J^{.5}/cm^{1.5} | | | | |

TABLE 8
Injection Molded-Effect of Type of Septon Rubber

| | Comp. | Comp. | Comp. | Comp. | Comp. | Comp. |
|---|---|---|---|---|---|---|
| | Ex. 25 | Ex. 26 | Ex. 27 | Ex. 28 | Ex. 29 | EX. 30 |
| Topas 6015 | 89.8 | 79.8 | 89.8 | 79.8 | 89.8 | 79.8 |
| Septon 2007 | 10 | 20 | | | | |
| Septon 2004 | | | 10 | 20 | | |
| Septon HG-252 | | | | | 10 | 20 |
| Irgafos 168 | 0.1 | 0.1 | 0.1 | 0.1 | 0.1 | 0.1 |
| FS-042 | 0.1 | 0.1 | 0.1 | 0.1 | 0.1 | 0.1 |
| Tens @ Yield (MPa) | 62.46 | 51.05 | 61.12 | 44.04 | 61.84 | 44.64 |
| Strain @ Yield (%) | 4 | 3.8 | 4.1 | 4 | 4.1 | 4.7 |
| Strain @ Break (%) | 4.7 | 4.4 | 6.6 | 6 | 6 | 15 |
| Flex Mod 1% sec (MPa) @ | 2772 | 2282 | 2689 | 1965 | 2730 | 2075 |
| 0.05 in/min | | | | | | |
| Flex Mod 1% Tan (MPa) @ | 2689 | 2330 | 2654 | 1958 | 2620 | 2199 |
| 0.05 in/min | | | | | | |
| HDT @ 0.46 MPa (C.) | 144.5 | 143.6 | 144.5 | 141.7 | 144.9 | 141 |
| HDT @ 1.80 MPa (C.) | 127.5 | 124.5 | 127.7 | 122.2 | 127.3 | 121.5 |
| Notched Izod @ 23 C. (J/m) | 32.0 | 42.7 | 48.0 | 106.8 | 26.7 | 149.5 |
| Notched Izod @ −18 C. (J/m) | 26.7 | 32.0 | 26.7 | 32.0 | 21.4 | 42.7 |
| Bicerano Solubility | .53 | .53 | .53 | .53 | .48 | .48 |
| Parameter Difference J^{.5}/cm^{1.5} | −2.62 | −2.62 | −2.62 | −2.62 | −2.62 | |

Comparative Example 10 in Table 4 shows the characterization data for neat Topas 6015. Without addition of an elastomer the room temperature notched Izod impact is only 22.9 J/m. These brittle polymers certainly could not be used in automotive applications. The heat distortion temperatures (HDTs) at 0.46 MPa and 1.80 MPa of Comparative Example 10 are 144.9° C. and 128.5° C., respectively. These high HDT's can be achieved because of the 160° C. glass transition temperature for Topas 6015. These heat distortion temperatures are much higher than can be achieved with blends of polypropylenes.

In Comparative Examples 11-13, 19-20, 24, 26, 28 and 30, Topas 6015 is blended with 20 wt. % of a wide variety of elastomers. The room temperature notched Izod resistance of these samples are plotted in FIG. 3. As in the case of the compression molded samples, the elastomer blend component that is most effective at raising notched Izod impact at 23° C. is Vistalon 8600, an ethylene-propylene-ethylidene norbornene terpolymer containing 8.9 wt. % ethylidene norbornene.

In FIG. 3, it can be seen than Vistalon 7001 is also quite effective at toughening Topas 6015 (Comparative Example 12). Vistalon 7001 is an ethylene-propylene-ethylidene norbornene terpolymer, which contains only 5 wt. % ethylidene norbornene. This elastomer was less effective at toughening Topas 6015 in the compression molded samples. Its effectiveness in the extruded/injection molded specimens is probably due to better mixing in the twin screw extruder.

The styrenic block copolymers (Kratons and Septons) are all poorer than the Vistalons at improving the room temperature notched Izod impact resistance of Topas 6015. Note also that the ethylene plastomer, Exact 5061, (Comparative Example 24) and ethylene-propylene rubber, MDV91-9, (Comparative Example 19) are both significantly less effective at toughening Topas 6015 than the Vistalon 8600 and 7001 ethylene-propylene-ethylidene norbornene terpolymers. This result is unexpected based upon their similar compositions.

To explain the efficiency of the various elastomers, their Bicerano solubility parameters were determined and in FIG. 4 the room temperature notched Izod impact resistance for 20 wt. % blends are plotted against the differences between the Bicerano solubility parameters of Topas 6015 and each of the elastomers tested. Similar to the compression molding results in FIG. 2, the highest room temperature notched Izod impact results are observed when the differences between the Bicerano solubility parameters of the Topas 6015 and elastomers is between 0.2 and 0.4 J^{0.05}/cm^{1.5}. The Kratons, Septons, ethylene-propylene copolymer, and ethylene plastomers are all less effective at toughening than the Vistalons because they are less compatible (differ more in Bicerano solubility parameters) with Topas 6015.

The toughening is so effective with Vistalon 8600 that no breaks are observed in the notched Izod impact tests at 23° C. for Comparative Examples 17 and 20. No other elastomer tested at a 20 wt. % loading had no breaks in the room temperature notched Izod impact test, which is a requirement for many automotive applications.

The injection molded samples have also been characterized by the Instrumented Impact test at several temperatures. In this test a projectile is fired at a disk of polymer at either 5 or 15 miles per hour. A ductile failure is required by several automotive manufacturers for some applications. The neat Topas 6015 in Comparative Example 10 is too brittle to even be tested. The blends containing Topas 6015 and 20 wt. % elastomer, Vistalon 8600 (Comparative Examples 17 and 20), Vistalon 7001 (Comparative Example 12), Kraton G1650/G1651 (Comparative Example 11), Kraton G1650 (Comparative Example 13), and MDV91-9 (Comparative Example 19) all show ductile failures at room temperature. However, only the Vistalon 8600 (Comparative Example 17) and Vistalon 7001 (Comparative Example 12) are also ductile at −29° C. These outstanding low temperature Instrumented Impact results are possible, because the ethylene-propylene-ethylidene norbornene polymers in Vistalon 8600 and 7001 have very low glass transition temperatures and are compatible with Topas 6015 and 6017.

It will be seen that the sample in Comparative Example 22 (Topas 6015 blended with 20 wt. % Vistalon 8600) exhibited more than just ductile failures in the Instrumented Impact test at −29 C unlike the 80:20 Topas 6015/Vistalon 8600 sample of Comparative Example 17. This difference is observed because the Instrumented Impact test in Comparative Example 22 used a 15 pound weight fired at 25 m.p.h. at the polymer disk. These testing conditions deliver more energy to the test specimen, making it harder to pass with ductile failure.

In Example 4 and Comparative Examples 14-17 and 20, a series of Topas 6015 blends with different amounts of Vistalon 8600 were prepared using the twin screw extruder and injection molding machine. In FIG. 5 the room temperature notched Izod impact results for these blends are compared. An unexpected and highly nonlinear toughening occurs for blends containing 15% or more elastomer. The blend of Topas 6015 with 30 wt. % Vistalon 8600 (Example 4 of Table 7) has outstanding toughness. No breaks are observed in the room temperature and the −18° C. Izod impact tests. Only ductile failures are observed in the instrumented impact tests at 23° C. and −29° C. Example 4 even has ductile failures in the instrumented impact test, when the 15 pound weight is fired at the specimen at 25 m.p.h. The strain at break of 25.6% is a strong indicator of just how tough this blend is compared with the starting Topas 6015. The heat distortion temperatures at 0.46 and 1.80 MPa of 139.2 and 117.5° C. are significantly higher than can be achieved with high impact blends of polypropylene.

Comparative Example 23 illustrates that it is not just the high loading of elastomer that is necessary to toughen Topas 6015. This Comparative Example used 30 wt. % of a high impact polypropylene to toughen the cyclic olefin copolymer. A poor room temperature notched Izod impact resistance of only 32.9 J/m was obtained. In order to achieve high impact modification, the elastomer needs also to be compatible (i.e., the difference in Bicerano solubility parameters needs to be between 0 and 0.6, preferably between 0.2 and 0.4 J^{0.5}/cm^{1.5}) with the Topas 6015.

Topas 6017 is an ethylene/norbornene copolymer with a glass transition temperature of 180° C. It is slightly more difficult to toughen than Topas 6015. See comparisons between blends of Topas 6015 and 6017 for 10 wt. % Vistalon 8600 (Comparative Examples 18 and 21 in Table 6), 20 wt. % Vistalon 8600 (Comparative Examples 20 and 22 in Table 6), and 30 wt. % Vistalon 8600 (Examples 4 and 5 in Table 7). At the same loading of Vistalon 8600, the Topas 6017 blends have slightly lower notched Izod impact values than the Topas 6015 blends. However, both cyclic olefin copolymers reach the target of 500 J/m notched Izod impact resistance when loaded with 30 wt. % Vistalon 8600.

The Topas 6017 blends have higher heat distortion temperatures at 0.46 MPa (for example 159 vs. 142.9 C for 20 wt. % Vistalon 8600) and 1.80 MPa (for example 138 vs. 121.3 for 20 wt. % Vistalon 8600) due to the higher glass transition temperature of the Topas 6017.

In FIG. 6, the properties of a commercial high impact polypropylene (ExxonMobil PP8224E1) is compared those of with Examples 4 and 5 of Table 7. All three blends had no breaks in the room temperature notched Izod impact test (not shown in FIG. 6). The two ethylene/norbornene blends had about the same instrumented impact energies as the polypropylene sample, even though they were measured with the 15 pound weight at 25 m.p.h. rather than the 117 pound weight at 5 m.p.h. reported for the high impact polypropylene. The higher speed instrumented impact tests are usually more stringent, suggesting that Examples 4 and 5 have slightly better impact properties than the polypropylene blend. Examples 4 and 5 have significantly higher tensile strengths, higher stiffness (flexural modulus), and higher heat distortion temperatures than the commercial polypropylene blend. The three materials have very similar densities. The high impact polypropylene blend is used around the world in automotive exterior applications that require low temperature ductility, such as bumper fascias.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby.

What is claimed is:

1. A polymer composition comprising:
(a) greater than 50 wt % (based upon the weight of the composition) of a cyclic olefin copolymer, said cyclic olefin copolymer comprising at least one acyclic olefin and at least 20 weight % of one or more cyclic olefins (based upon the weight of the cyclic olefin copolymer), wherein at least a portion of said cyclic olefin copolymer has a glass transition temperature of greater than 150° C.;
(b) less than 50 wt % (based upon the weight of the composition) of an acyclic olefin polymer modifier, at least a portion of the modifier having a glass transition temperature of less than −30° C.; and no portion of the modifier having a softening point greater than +30° C., the Bicerano solubility parameter of the modifier being no more than 0.6 J^{0.5}/cm^{1.5} less than the Bicerano solubility parameter of the cyclic olefin copolymer;
wherein the notched Izod impact resistance of the composition measured at 23° C. is greater than 500 J/m and the heat distortion temperature of the composition measured using a 0.46 MPa load is greater than 135° C.

2. The polymer composition of claim 1, wherein said cyclic olefin copolymer comprises at least 30 weight % of one or more cyclic olefins.

3. The polymer composition of claim 1, wherein said cyclic olefin copolymer comprises at least 40 weight % of one or more cyclic olefins.

4. The polymer composition of claim 1, wherein at least a portion of said cyclic olefin copolymer has a glass transition temperature greater than 160° C.

5. The polymer composition of claim 1, wherein at least a portion of said cyclic olefin copolymer has a glass transition temperature greater than 170° C.

6. The polymer composition of claim 1, wherein a portion of said cyclic olefin copolymer has a softening temperature of less than 30° C.

7. The polymer composition of claim 1, wherein all of said cyclic olefin copolymer has a glass transition temperature greater than 150° C.

8. The polymer composition of claim 1, wherein a portion of said polymer modifier has a glass transition temperature of less than −40° C.

9. The polymer composition of claim 1, wherein a portion of said polymer modifier has a glass transition temperature of less than −50° C.

10. The polymer composition of claim 1, wherein all of the said polymer modifier has a glass transition temperature of less than −30° C.

11. The polymer composition of claim 1, wherein no portion of said polymer modifier has a softening point greater than 10° C.

12. The polymer composition of claim 1, wherein said polymer modifier has an Bicerano solubility parameter 0.1-0.5 J^{0.5}/cm^{1.5} less than the Bicerano solubility parameter of the cyclic olefin copolymer.

13. The polymer composition of claim 1, wherein said polymer modifier has an Bicerano solubility parameter 0.2-0.4 J^{0.5}/cm^{1.5} less than the Bicerano solubility parameter of the cyclic olefin copolymer.

14. The polymer composition of claim 1 and comprising about 20 wt % to about 40 wt % of said polymer modifier.

15. The polymer composition of claim 1 and comprising about 25 wt % to about 35 wt % of said polymer modifier.

16. The polymer composition of claim 1, wherein the notched Izod impact resistance of the composition measured at 23° C. is greater than 550 J/m.

17. The polymer composition of claim 1, wherein the notched Izod impact resistance of the composition measured at 23° C. is greater than 600 J/m.

18. The polymer composition of claim 1, wherein the notched Izod impact resistance of the composition measured at 23° C. is greater than 700 J/m.

19. The polymer composition of claim 1, wherein the heat distortion temperature of the composition measured using a 0.46 MPa load is greater than 150° C.

20. The polymer composition of claim 1, wherein the heat distortion temperature of the composition measured using a 0.46 MPa load is greater than 165° C.

21. The polymer composition of claim 1, wherein the heat distortion temperature of the composition measured using a 1.80 MPa load is greater than 115° C.

22. The polymer composition of claim 1, wherein the heat distortion temperature of the composition measured using a 1.80 MPa load is greater than 130° C.

23. The polymer composition of claim 1, wherein the heat distortion temperature of the composition measured using a 1.80 MPa load is greater than 145° C.

24. The polymer composition of claim 1, wherein notched Izod impact resistance of the composition measured at −18° C. is greater than 50 J/m.

25. The polymer composition of claim 1, wherein notched Izod impact resistance of the composition measured at −18° C. is greater than 150 J/m.

26. The polymer composition of claim 1, wherein notched Izod impact resistance of the composition measured at −18° C. is greater than 300 J/m.

27. The polymer composition of claim 1, wherein notched Izod impact resistance of the composition measured at −18° C. is greater than 500 J/m.

28. The polymer composition of claim 1, wherein the instrumented impact energy of the composition measured at 23° C. is greater than 25 J.

29. The polymer composition of claim 1, wherein the instrumented impact energy of the composition measured at 23° C. is greater than 30 J.

30. The polymer composition of claim 1, wherein the instrumented impact energy of the composition measured at −29° C. is greater than 25 J.

31. The polymer composition of claim 1, wherein the instrumented impact energy of the composition measured at −29° C. is greater than 30 J.

32. The polymer composition of claim 1, wherein the flexural modulus of the composition measured using the 1% secant method is greater than 1200 MPa.

33. The polymer composition of claim 1, wherein the flexural modulus of the composition measured using the 1% secant method is greater than 2000 MPa.

34. The polymer composition of claim 1, wherein the flexural modulus of the composition measured using the 1% secant method is greater than 2500 MPa.

35. The polymer composition of claim 1, wherein said polymer modifier comprises a copolymer of ethylene, a higher alpha-olefin, and at least 5 wt % but less than 20 wt % of a cyclic olefin.

36. The polymer composition of claim 35, wherein the cyclic olefin is selected from norbornene, ethylidene norbornene, vinylnorbornene, vinylcyclohexene and dicyclopentadiene.

37. The polymer composition of claim 35, wherein the alpha olefin is selected from propylene, hexene and octene.

38. The polymer composition of claim 1, wherein said polymer modifier comprises a polymer comprising ethylene, propylene, and optionally one or more dienes.

39. The polymer composition of claim 38, wherein the polymer comprises from about 25 to about 80 wt % of ethylene, up to 15 wt % of one or more dienes and the balance propylene.

40. The polymer composition of claim 1, wherein said polymer modifier comprises a copolymer of ethylene and 7-methyl-1,6-octadiene.

41. The polymer composition of claim 1, wherein said cyclic olefin copolymer comprises a copolymer of ethylene with norbornene and/or dicyclopentadiene.

42. The polymer composition of claim 1, wherein some or all of the remaining double bonds of the cyclic olefin copolymer are hydrogenated, epoxidized and/or functionalized.

43. The polymer composition of claim 1 and comprising a melt blend of said cyclic olefin copolymer (a) and said polymer modifier (b).

44. A component for an automobile fabricated from the polymer composition of claim 1.
